(19) United States
(12) Patent Application Publication
(10) Pub. No.: US 2012/0259826 A1
(43) Pub. Date: Oct. 11, 2012

(54) Customizable Interfacing Agents, Systems, And Methods

(76) Inventor: Rym Zalila-Wenkstern, Plano, TX (US)

(21) Appl. No.: 13/436,468

(22) Filed: Mar. 30, 2012

Related U.S. Application Data
(60) Provisional application No. 61/473,677, filed on Apr. 8, 2011.

(51) Int. Cl. G06F 17/30; G06F 3/048

(52) U.S. Cl. 707/706; 715/744; 707/E17.108

(57) ABSTRACT

Customizable interfacing agents, systems, and methods are provided. In one embodiment, a method for interfacing a user to service providers includes receiving a set of user attributes associated, with a user to form a user profile, receiving a request for data from the user, and sending the request to one or more service providers. The method also includes receiving response data from the one or more service providers in response to sending the request to the one or more service providers. The method also includes filtering the response data from the one or more service providers using the user profile to form user-customized response data, and presenting the user-customized response data to the user.

### CROSS-REFERENCE TO RELATED APPLICATIONS

This application claims the benefit of U.S. Provisional Application No. 61/473,677 filed Apr. 8, 2011, which is hereby incorporated by reference.

### TECHNICAL FIELD

The illustrative embodiments relate generally to interfacing users in or to a network environment. More particularly, the illustrative embodiments relate to customizable interfacing agents, systems, and methods.

### BACKGROUND

As computer technology, including networking and Internet technology, proliferates, increasing amounts of information become available to users. Indeed, the massive amount of data available to users via the Internet can be overwhelming, sometimes causing users to spend unnecessary resources or time in accessing various service providers, comparing, managing, or organizing data from service providers, making decisions based on the data from websites, etc. Current interfacing systems for users may fail to provide a centralized or unified interface with which to communicate with multiple different types of service providers or users. Current systems may also fail to customize data available over the Internet based on a user profile, including any preferences or attributes of the user. Current systems may further fail to provide a versatile, or universally adaptable, interface between users and service providers or other users so that the massive amounts of data available over a communication medium, such as the Internet, can be effectively managed by users.

### SUMMARY

According to an illustrative embodiment, a method for interfacing a user to service providers includes receiving a set of user attributes associated with a user to form a user profile, receiving a request for data from the user, and sending the request to one or more service providers. The method also includes receiving response data from the one or more service providers in response to sending the request to the one or more service providers. The method also includes filtering the response data from the one or more service providers using the user profile to form user-customized response data, and presenting the user-customized response data to the user.

According to another illustrative embodiment, a method for providing an interface between interfacing agents includes receiving a set of user attributes associated with a user to form a user profile, receiving a request for data from the user, and sending the request to one or more interfacing agents. Each of the one or more interfacing agents is associated with a respective user profile for a respective user. The method includes receiving response data from the one or more interfacing agents in response to sending the request to the one or more interfacing agents. The method also includes filtering the response data from the one or more interfacing agents using the user profile to form user-customized response data, and presenting the user-customized response data to the user.

According to another illustrative embodiment, a system for interfacing a user includes an interfacing agent implementable on a communication device. The interfacing agent is adapted to communicate with a plurality of service providers and external interfacing agents. The interfacing agent receives a request for data from a user and sends the request to at least one of the plurality of service providers and external interfacing agents. The interfacing agent receives response data from the at least one of the plurality of service providers and external interfacing agents in response to sending the request to the at least one of the plurality of service providers and external interfacing agents. The interfacing agent includes a user profile including a set of user attributes associated with the user. The interfacing agent also includes a filtering engine to filter the response data from the at least one of the plurality of service providers and external interfacing agents using the user profile to form user-customized response data. The interfacing agent presents the user-customized response data to the user.

### BRIEF DESCRIPTION OF THE DRAWINGS

FIG. 1 is a schematic, pictorial representation of an interfacing system according to an illustrative embodiment;

FIG. 2 is a schematic, block diagram of an interfacing system according to an illustrative embodiment;

FIG. 3 is a schematic, block diagram of interfacing agents in data communication with one another according to an illustrative embodiment;

FIG. 4 is a schematic, graphical representation of user attributes separated into categories for use by a user profile according to an illustrative embodiment;

FIG. 5 is a schematic, pictorial representation of a graphical user interface of an interfacing agent prompting a user to enter profile information according to an illustrative embodiment;

FIG. 6 is a schematic, pictorial representation of a graphical user interface of the interfacing agent in which the user has inputted a request according to an illustrative embodiment;

FIG. 7 is a schematic, pictorial representation of a graphical user interface of the interfacing agent notifying the user of a search status according to am illustrative embodiment;

FIG. 8 is a schematic, pictorial representation of an interfacing agent processing a request from a user and sending the processed request to one or more service providers according to an illustrative embodiment;

FIG. 9 is a schematic, pictorial representation of an interfacing agent processing response data received from one or more service providers according to an illustrative embodiment;

FIG. 10 is a schematic, pictorial representation of an interfacing agent processing a request from a user relating to social networking service providers according to an illustrative embodiment;

FIG. 11 is a schematic, pictorial representation of an interfacing agent processing a request from a user relating to sharing on social networking service providers according to an illustrative embodiment;

FIG. 12 is a flowchart of a process for interfacing a user to service providers according to an illustrative embodiment;

FIG. 13 is a flowchart of a process for interfacing a user to service providers according to another illustrative embodiment;

FIG. 14 is a flowchart of a process for interfacing a user to interfacing agents according to an illustrative embodiment;

FIG. 15 is a schematic, pictorial representation of an example architecture of an interfacing system according to an illustrative embodiment;

FIG. 16 is a schematic, block diagram of an example agent host according to an illustrative embodiment;

FIGS. 17A-17D are schematic, pictorial representations of agent host delegation according to an illustrative emabodiment;

FIGS. 18A-18J are schematic, pictorial representations of example graphical user interfaces for creating user accounts and setting preferences according to an illustrative embodiment;

FIGS. 19A-19O are schematic, pictorial representations of example graphical user interfaces for scheduling user activities according to an illustrative embodiment;

FIGS. 20A-20I are schematic, pictorial representations of example graphical user interfaces for sharing planned activities with other users according to an illustrative embodiment;

FIGS. 21A-21H are schematic, pictorial representations of example graphical user interfaces for planning group activities according to an illustrative embodiment;

FIG. 22 is a schematic, block diagram of a data processing system in which the illustrative embodiments may be implemented; and

FIG. 23 is a schematic, pictorial representation of an example agent platform according to an illustrative embodiment.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

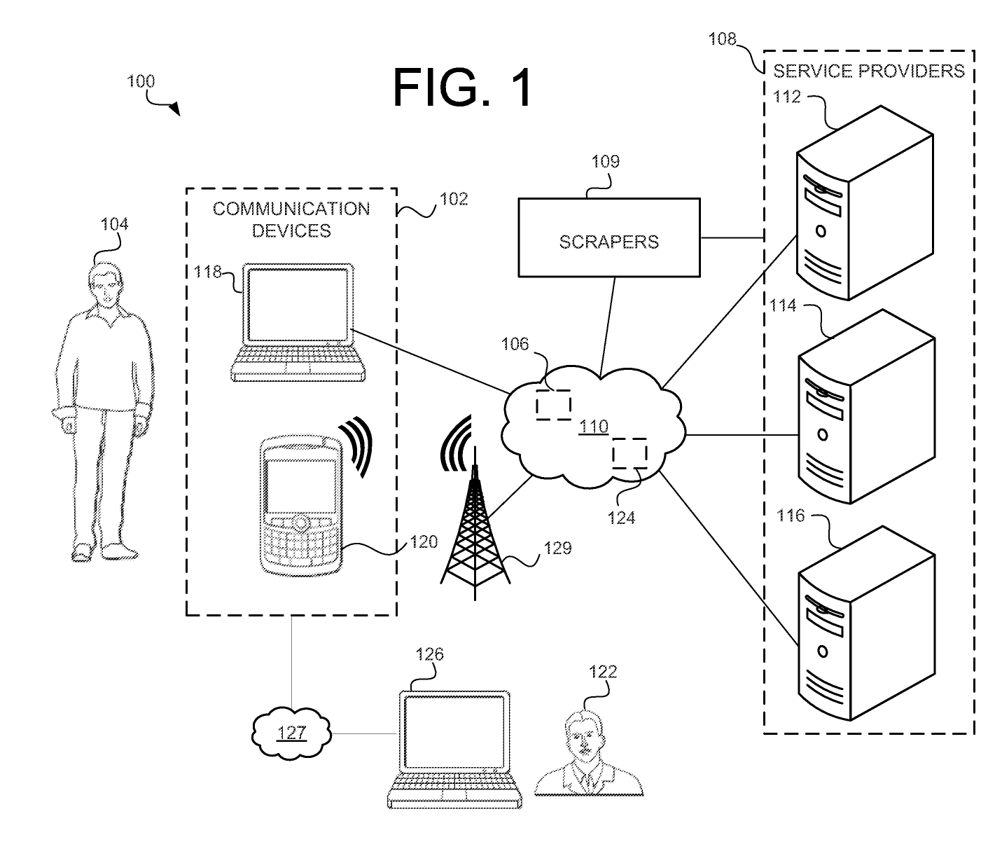

Referring to FIG. 1, an illustrative embodiment of an interfacing system 100 includes one or more communication devices 102 usable by the user 104, each of which may implement an interfacing agent 106. In one embodiment, the interfacing agent 106 may be autonomous software capable of interacting, collaborating, and/or negotiating with other software, as well as or including the service providers 108, scrapers 109, and the second interfacing agent 104, to achieve an individual or global goal. The interfacing agent 106 may be operable by the user 104 to interface, or otherwise communicate, with one or more service providers 108. A service provider 108 may be any entity, website, or other provider of services utilizing a data communication medium 110, such as the Internet, to deliver services. Unless otherwise indicated, as used herein, “or” does not require mutual exclusivity.

In one embodiment, each of the service providers 108 may be implemented by one or more servers 112, 114, 116. In one non-limiting example, a search engine service provider, such as a website that provides Internet search services (e.g., Google®, Yahoo®, Wikipedia®, etc.), may be implemented by the server 112, a news service provider, such as a website that provides news, may be implemented by the server 114, and a social networking service provider, such as a website that provide social networking services (e.g., Facebook®, LinkedIn®, Twitter®, Foursquare®, etc.), may be implemented by the server 116. Other non-limiting examples of service providers 108 may include gaming service providers, including websites that offer video game services, travel service providers, financial data service providers, chat service providers, and other online entities or websites that provide services to users. Also, amy number of service providers 108 may be interfaced with the user 104 via the interfacing agent 106 (e.g., dozens, hundreds, thousands, millions, etc.).

In one embodiment, scrapers 109 comprise a library of Java programs that intelligently acquire publicly-available data from other websites and web services, including from service providers 108. Scrapers 109 may comprise a collection of Java classes that “scrape” websites for information needed for user agents to make decisions based on user requests. Scrapers 109 may be used to collect data when a service provider does not have an API with which the interfacing agent can communicate. An API is a source code-based specification intended to be used as an interface by software components to communicate with each other.

The interfacing agent 106 may be executed or accessed by, deployed onto, or installed on any communication device 102 usable by the user 104. In one embodiment, interfacing agent 106 may reside loud server and may be accessed through a user's communication device via a network. In the non-limiting example of FIG. 1, the interfacing agent 106 may be accessed by any of the user's communication devices 102, namely, a laptop 118 and a cellular phone 120. The user 104 may be provided easier access to the interfacing agent 106 since he or she may use the interfacing agent 106 on any of his or her communication devices 102.

The communication devices 102 through which the interfacing agent 106 may be executed, or accessed may be any device capable of communicating with another device. For example, the communication devices 102 may include a computer (e.g., a laptop, netbook, tablet computer, desktop computer, or minicomputer), a cellular phone (e.g., a smart phone), a personal digital assistant, a kiosk, a portable gaming device, a web browsing device, a media player, or any electronic device capable of communicating over the data communication medium 110.

In one embodiment, the user 104 may interact with the interfacing agent 106 to eliminate or reduce the need for interacting with the service providers 108 directly. For example, instead of directly entering search terms into a search engine service provider website, the user 104 may enter the search terms into the interfacing agent 106, which then communicates with one or more search engine service providers to provide search results back to the user 104.

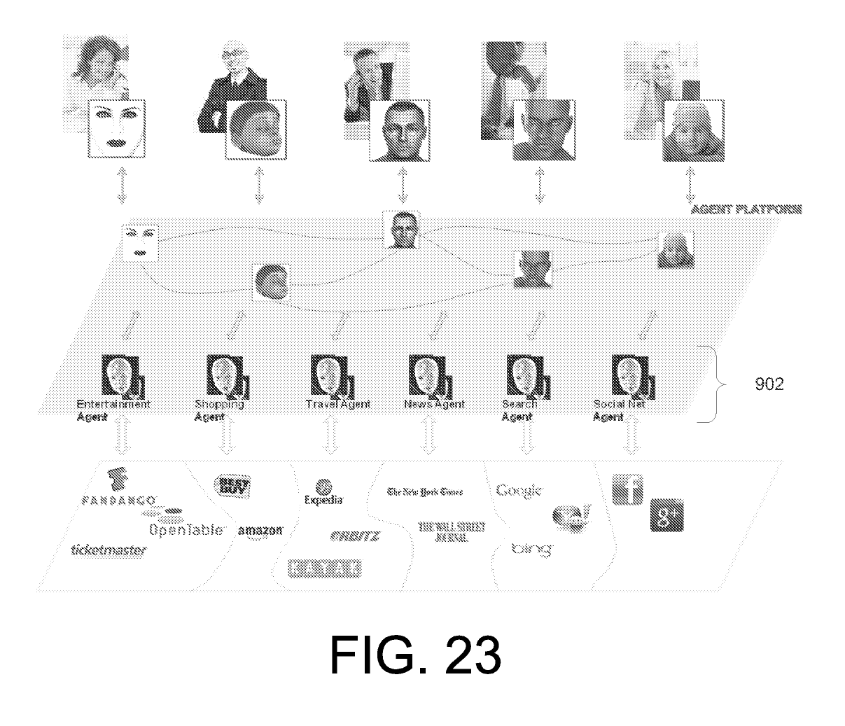

In one embodiment, the interfacing agent 106 presents the user 104 with customized data that is based on a user profile containing user attributes about the user 104. The interfacing agent may collect data in various ways, including through APIs and scrapers. When the user 104 makes a request to the interfacing agent 106, this request may be sent or relayed to one or more of the service providers 108, or to one or more scrapers 109 (if a service provider does not provide an API). It should be noted that in one embodiment shown in FIG. 23, the interfacing agent 106 may also send the request to a specialized agent 902 (e.g., entertainment agent, news agent, etc.) that handles the interactions between the interfacing agent and the appropriate service provider. These specialized agents are not associated with any particular user, but rather they are agents that specialize in interacting with a particular subset of service providers (news providers, shopping providers, travel providers, etc.). The specialized agents perform the information groundwork for the interfacing agent 106, thereby relieving the interfacing agent 106 of the burden of interacting with multiple providers to provide a response to the user's request for information. When the service providers 108 or scrapers 109 receive the request, the service providers 108 or scrapers 109 may send response data back to the interfacing agent 106, which then filters the response data based on the user profile of the user 104 to form or generate user-customized response data. This user-customized response data may then be presented to the user 104. Because the user-customized response data has been processed to remove response data that is not pertinent to the user 104, such as by removing data that does not match the user's preferences or attributes as defined in the user profile, the user 104 may be presented with customized data that effectively reduces the volume of data the user 104 receives. In this manner, the interfacing agent 106 may assist the user 104 in managing the voluminous amount of data available from the service providers 108 by presenting or displaying only that data which is pertinent to the user 104.

It will be appreciated that the interfacing agent 106 allows the user 104 to interface with any type of service provider 108. By way of non-limiting example, the user 104 may use the interfacing agent 106 to find airline tickets or other travel-related items or services, in which case the interfacing agent 106 acts as an interface between the user 104 and the service providers 108 that provide travel-related services, such as airline ticket search services. The airline tickets or other travel-related items or services may be filtered by the interfacing agent 106 using the user profile of the user 104 to further narrow the results displayed to the user 104. The types of service providers 108 with which the interfacing agent 106 interacts may be defined by the user 104, determined by the request from the user 104, determined by an administrator of the interfacing agent 106, etc. The service providers 108 with which the interfacing agent 106 interacts may also, for example, be defined by the user's profile; in this example, the user 104 may, for example, define that he or she only wants to purchase certain good or services from particular vendors.

Other types of requests may be made by the user 104 to the interfacing agent 106. For example, in the social networking context, the user 104 may send a request to the interfacing agent 106 to receive data (e.g., update statuses, photos, events, etc.) from a social networking website, such as Facebook®. In this embodiment, the interfacing agent 106 may have or implement a graphical user interface that presents data from social networking service providers on a display of one of the communication devices 102. The response data received from the social networking website as a result of the user's request may be filtered by the interfacing agent 106 using the user's profile so that only data from the social networking website that is pertinent to the user's interests or other attributes are presented to the user 104.

In one embodiment, in addition to interfacing the user 104 with the service providers 108, the interfacing agent 106 may also interface the user 104 with a second user 122 to facilitate agent-to-agent communication. For example, the interfacing agent 106 of the user 104 may directly or indirectly interface with a second interfacing agent 124 used by the second user 122. The second interfacing agent 124 may be implemented on any communication device 126 usable by the second user 122.

While FIG. 1 shows two interfacing agents 106, 124 communicating with one another to interface two users 104, 122, the interfacing system 100 may include any number of interfacing agents (e.g., dozens, hundreds, thousands, millions, etc.) that allow their respective users to interface with one another. In the embodiment in which the interfacing agents 106, 124 interact directly with one another, the user 104 may use the interfacing agent 106 to perform various functions that are assisted by the availability of the user profile on both the interfacing agent 106 and the second interfacing agent 124.

For example, the user 104 may enter a request to match the user 104 with another user, such as the second user 122, based on his or her interest or attributes. In this example, the user 104 may have a user profile that indicates that he or she has a skateboarding interest. In response to a request from the user 104 to find friends, the interfacing agent 106 may find users having user profiles indicating an interest in skateboarding, and present user-identifying data, such as the located user's names, to the user 104. The user 104, after receiving user-identifying data about the users having similar interests, may request the interfacing agent 106 to interface with the interfacing agents of the users having similar interests so that a communication link between the users may be made. In another embodiment, communication between the interfacing agents 106, 124 may be used to match users that are interested in dating by finding companions having similar interests based on their respective user profiles. In this example, the user profiles of the respective users may be compared with one another so that users having similar or complementary interests according to their user profiles are matched with one another via the interfacing agents 106, 124. In another embodiment, communication between the interfacing agents 106, 124 may be used to plan activities between users that are interested in attending an event (e.g., a movie, dinner at a restaurant, etc.) by determining activity options for the users based on their respective user profiles. Communication between the interfacing agents 106, 124 may also facilitate social networking opportunities, as information (text, photos, posts, etc.) input or selected by a user and received by interfacing agent 106 may be shared with interfacing agent 124, and thus shared with another user. The interfacing agents 106, 124 may also filter the information shared by other users, thereby providing the user with the ability to see only what the user wants to see.

In another embodiment, applications may be created and/or implemented on the interfacing agents 106, 124 to allow for additional functionality for the users 104, 122. For example, a gaming application (e.g., chess, poker, adventure games, etc.) may be implemented by the interfacing agents 106, 124 so that the users 104, 122 may play a game with one another via the interfacing agents 106, 124.

Applications may be developed that facilitate or customize interaction between the user 104 and the service providers 108. For example, an application may be implemented by the interfacing agent 106 that delivers user-customized, or filtered, data that matches predetermined criteria defined by first user 104 to the second interfacing agent 124 of the second user 122. Indeed, the types of applications that may be implemented by the interfacing agents 106, 124 are numerous. By providing a platform on which to implement applications, the interfacing agents 106, 124 may be further customized, scaled, or adapted to the needs of particular users or entities.

Customization of the user experience in using the interfacing agent 106 may be facilitated by the use of a user profile, stored by the interfacing agent 106, which contains user attributes about the user 104. The user profile may be stored on a memory or storage on one of the communication devices 102, or may be stored elsewhere, such as on a cloud-computing platform or another user's communication device. It will be appreciated that the versatility of the interfacing agent 106 may be increased by the ability of the interfacing agent 106 to interface with a wide variety of service providers 108, as well as other interfacing agents 124. Therefore, unless otherwise desired by, e.g., the user, the interfacing agent 106 may be able to interact with service providers 108, including websites, which span a wide range of fields, including those mentioned herein. In one embodiment, the interfacing agent 106 may provide a unified or centralized interface for the user 104 that may prevent or reduce the need for the user 104 to interact with numerous service providers 108 directly, and ease or simplify the computing experience for the user 104.

The techniques, technologies, or media by which the components of the interfacing system 100 intercommunicate are numerous. For example, the interfacing system 100, or any portion thereof, may be part of a personal area network (PAN), a local area network (LAN), a campus area network (CAN), a metropolitan area network (MAP), or any other network type. Also, communication between any two of the elements in the interfacing system 100 may be direct or indirect, and may also utilize a cloud-based platform. Data communication medium 110 between the communication devices 102 and the service providers 108 and the data communication medium 127 between the communication devices 102 and the communication device 126 may be any medium through which data can be communicated. For example, the data communication medium 110 may be wired or wireless data connections, and may utilize a virtual private network (VPN), multi-protocol label switching (MPLS), the Internet, or any other data communication media.

Wireless communication between the cellular phone 120 and the base station 129 may utilize any wireless standard for communicating data, such as CDMA (e.g., cdmaOne or CDMA2000), GSM, 3G, 4G, Edge, an over-the-air network, Bluetooth, etc. Any of the transactions occurring in the interfacing system 100 may be performed using secure SSL transactions. Also, the interfacing agent 106 may be implemented as software, firmware, or any other program or computer-readable instructions.

In one example, the interfacing system 100 may utilize the Internet, with any combination of the data communication media 110, 127 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIG. 1 is intended as an example, and not as an architectural limitation for the different illustrative embodiments.

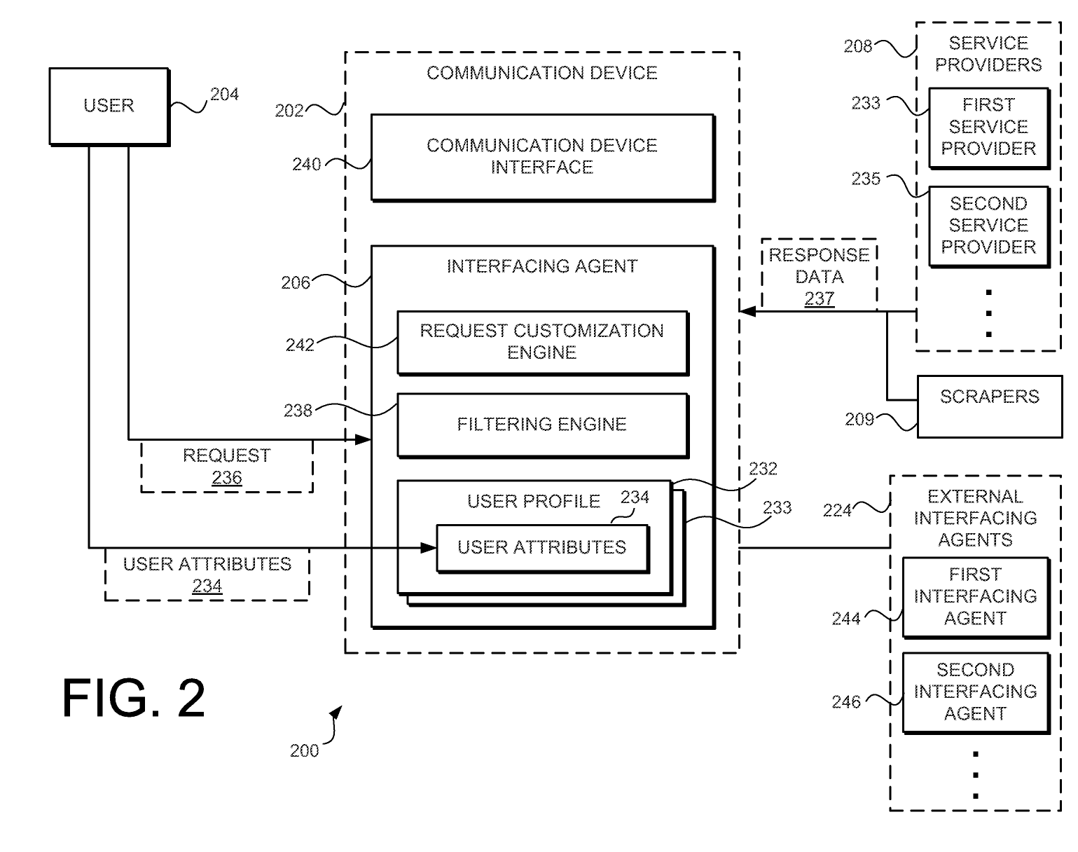

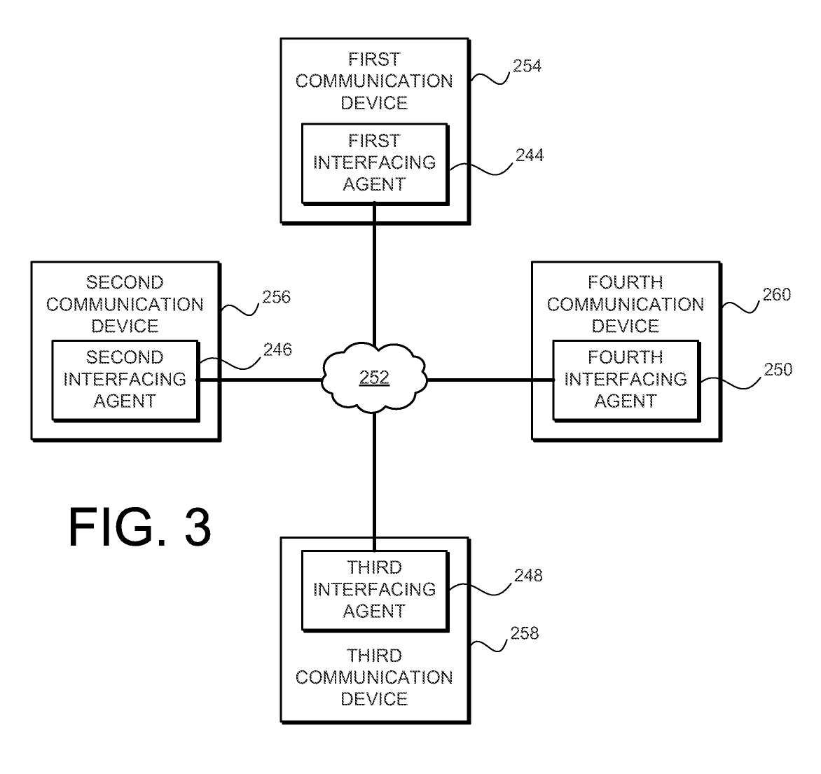

Referring to FIGS. 2 and 3, an illustrative embodiment of the interfacing agent 206 implemented or executed on the communication device 202 is shown. Elements of FIGS. 2 and 3 that are analogous to elements in FIG. 1 have been shown, by indexing the reference numerals by 100. The interfacing system 200 may include any number of service providers 208. For purposes of illustration, the service providers 208 shown in the interfacing system 200 include a first service provider 233 and a second service provider 235, and the service providers 233, 235 may provide any type of service over a network, including the services referred to herein.

The interfacing agent 206 may include a user profile 232 that includes a set of user attributes 234 about, or associated with, the user 204. As used herein, the term “set” encompasses a quantity of one or more. The user attributes 234 may include any type of attribute about the user 204. For example, the user attributes 234 may include occupational data or history about the user 204, biographical data about the user 204, educational data or history about the user 204, residence data, past or present, about the user 204, entertainment preferences of the user 204 (e.g., restaurant preferences, nightlife preferences, lunch preferences, maximum distance willing to drive for entertainment destinations, etc.), data about the friends, network, or acquaintances of the user 204, hobbies or interests of the user 204, travel preferences of the user 204, or any other preferences, data, or attributes of the user 204.

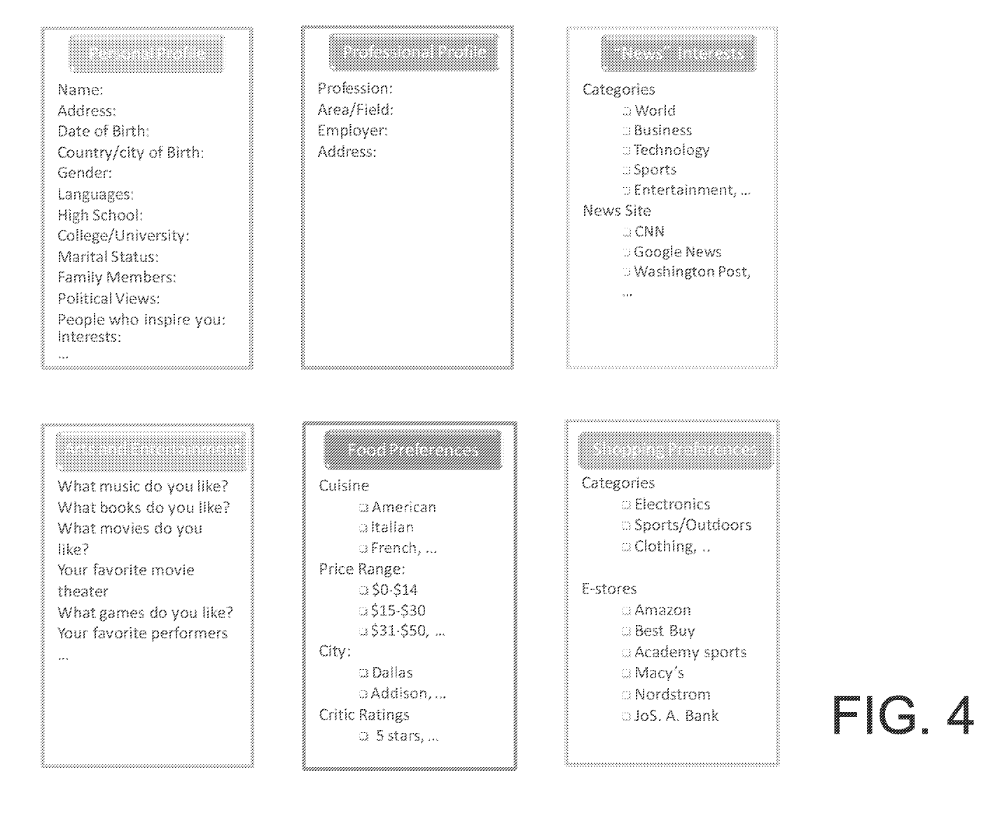

Additional non-limiting examples of the user attributes 234 are shown in FIG. 4. FIG. 4 also illustrates that the user profile 232 may categorize the user attributes 234 into subject matter categories, such as personal profile, professional profile, “news” interests, arts and entertainment, food preferences, shopping preferences, etc.

The user profile 232 may be formed in a variety of ways. In one embodiment, the user attributes 234 may be inputted by the user 204 into the interfacing agent 206. Based on the user attributes 234 received from the user 204, the interfacing agent 206 may generate the user profile 232. In another embodiment, multiple profiles for a user may be employed. For instance, when the user 204 first inputs user attributes 234, the interfacing agent 206 may generate the user profile 232. However, once the interfacing agent 206 starts “working” for the user 204, the interfacing agent 206 may create another user profile for the user 204. This second user profile, or selection-based user profile 233, may comprise attributes about the user 204 that reflect the preferences and selections the user has made in since inputting the user's initial attributes. The interfacing agent 206 may, at any time or at scheduled intervals, compare the attributes in the user-inputted user profile 232 and the interfacing agent's selection-based user profile 233 to determine if the attributes in the interfacing agent's selection-based user profile differ from the attributes in the user-inputted user profile. For example, if the user profile 232 for the user 204 indicates that the user loves Italian cuisine but the user has consistently selected to patronize Chinese restaurants for the last several weeks (as reflected in the selection-based user profile), the interfacing agent 206 may determine that the attributes in the user-inputted user profile may need updating to reflect the user's current preferences. In such a case, the interfacing agent 206 may request the user update the user profile 232 to reflect the user's current preferences.

The user attributes 234 about the user 204 may also be received from sources other than the user 204. For example, the interfacing agent 206 may retrieve data about the user 204 from a memory or storage in the communication device 202, such as the user's Internet browsing history, cookies, e-mails, files, etc. The interfacing agent 206 may also obtain the user attributes 234 about the user 204 over a network connection, such as the Internet; in this embodiment, the interfacing agent 206 may request data about the user 204 from a source other than the communication device 202 over a network connection, including from the service providers 208 (including via scrapers 109), or the external interfacing agents 224.

The interfacing agent's 206 acquisition of the user attributes 234 may be static or dynamic, or both. For example, if the user profile 232 is static, the user attributes 234 may be inputted by the user 204 at one or more particular times, and the user profile 232 may remain static until the user 204 desires to change the user profile 232. In an embodiment in which the user profile 233 is dynamic, the interfacing agent 206 may continuously or periodically access various sources, such as the user 204, the communication device 202, the service providers 208, the external interfacing agents 224, or any other source to continuously or periodically update the selection-based user profile 233 with the user attributes 234 of the user 204. As previously mentioned, the interfacing agent 206 may compare the user-inputted user profile 232 and the selection-based user profile 233 to determine whether the profiles differ from one another. While the selection-based user profile 233 is continuously updated to reflect the user's selection preferences, the interfacing agent 206 may request that the user update the user-inputted user profile 232 if the selection-based user profile 233 differs from the user-inputted user profile 232.

In one embodiment, the user 204 may send a request 236 to the interfacing agent 206. The content of the request 236 may depend on the type of data or service provider 208 that the user 204 desires. For example, if the user 204 desires to interact with one or more search engine service providers, the request 236 may be one or more search terms that the user 204 enters into the interfacing agent 206. In another example, if the service provider 208 with which the user 204 desires to interact is a social networking service provider, the request 236 may be one or more terms related to a social networking function, such as the name of a person, place, event, etc. In another example, the user 204 may retrieve news-related information from a news service provider using the interfacing agent 206, and the user 204 may input a request 236 associated with the type of news or event that the user 204 desires to learn about.

In one embodiment, the interfacing agent 206 may send the request 236 to one or more of the service providers 208 or scrapers 209. The service providers 208 or scrapers 209, upon receiving the request 236, may perform a searching or retrieval function to retrieve data associated with the request 236. For example, if the service provider 208 is a search engine service provider, the search engine service provider may perform a search using the one or more words or terms in the request 236 to generate search results.

One or more of the service providers 208 or scrapers 209 may generate, or retrieve, response data 237 in response to the request 236 received from the interfacing agent 206. The response data 237 may be sent from the one or more service providers 208 or scrapers 209 to the interfacing agent 206.

By way of non-limiting example, the request 236 may include one or more search terms that are sent to the first service provider 233, which may be a search engine service provider. The first service provider 233 may then perform a search, such as an Internet search, using the one or more search terms in the request 236 to generate response data 237 that includes search results. The response data 237, including the search results generated by the first service provider 233, may then be sent to the interfacing agent 206.

To provide a non-limiting specific example, the user 204 may desire to retrieve prices on flights between two destinations. In this example, the request 236 may include one or more words that describe the flight desired by the user 204 (e.g., flight from Dallas to New York on Apr. 13, 2011). The interfacing agent 206 may then send this request 236 to one or more service providers 208 that provide the service of searching for and/or retrieving airfares. Upon retrieving the airfares based on the request 236, the one or more service providers 208 may send the response data 237, including the resulting airfares data found by their respective searches, to the interfacing agent 206.

In another example, user 204 may desire to receive status updates from friends on a social networking service provider. In this example, the request 236 may contain the names of the friends for which the user 204 desires to see status updates, or any keywords related to the types of status updates the user 204 desires to view. The interfacing agent 206 may then send or relay the request 236 to one or more social networking service providers, which perform a search of status updates and return the status updates pertaining to the request 236 back to the interfacing agent 206 in the form of response data 237.

Indeed, as illustrated, by the above non-limiting examples, the types of requests 236 receivable from the user 204 may pertain to a wide variety of services deliverable over a network, and can take any form. Also, the request 236 may be a one-time event, a repeat event, or a continuous event. For example, the request 236 from a user desiring status updates from a social networking service provider may be received from the user 204, or sent by the interfacing agent 206, on a continuous or periodic basis (e.g., hourly, daily, weekly, etc.).

In one embodiment, the interfacing agent 206 may include a filtering engine 238. The filtering engine 238 may filter the response data 237 received from the one or more service providers 208 using the user profile 232 to form user-customized response data to present to the user 204. As used herein, “filtering” may include analyzing, comparing, or otherwise processing the response data using the user profile. The user-customized response data may be presented on a communication device interface 240 of the communication device 202. The filtering engine 238 may filter the response data 237 in a variety of ways so that only the portion of the response data 237 most relevant to the user 204, based on the user profile 232, is presented to the user 204.

In one embodiment, the filtering engine 238 may compare the response data 237 to the user attributes 234 in the user profile 232 to determine user-customized response data that most pertains to the user 204. For example, the filtering engine 238 may retain one or more portions of the response data 237 that is relevant to terms in the user profile 232 for inclusion in the user-customized response data presented to the user 204. The filtering engine 238 may also discard, one or more portions of the response data 237 that are not relevant to the user profile 232 and exclude these non-relevant portions from the user-customized response data so that these non-relevant portions are not presented to the user 204.

By way of non-limiting example, in the embodiment in which the interfacing agent 206 provides an interface between the user 204 and a search engine service provider, the filtering engine 238 may filter the one or more search results from, the search engine service provider, using the user profile 232, to generate or form user-customized search results that most pertain to the user 204. These user-customized search results may then be presented to the user 204 on the communication device interface 240. Thus, in one embodiment, the user 204 may achieve a greater level of customization using the interface agent 206 than could have been achieved by the user 204 directly interfacing the search engine service providers.

The response data 237 from other types of service providers, such as social networking service providers, news service providers, gaming service providers, specialized service providers, etc. may also be filtered by the filtering engine 238 using the user profile 232. It will be appreciated that the user 204, by having a user profile 232 loaded onto an interfacing agent 206 that is usable with a wide variety of service providers 208, may reduce the need for providing his or her user attributes 234 to a large number of entities, and instead have the user profile 232 in a centralized or local location.

Various filtering techniques (analyzing, processing, etc.) may be applied to the collected data prior to the information being presented to the user. In one scenario, consider that the interfacing agent is a “weekend planner”. In this scenario, the user asks his interfacing agent to plan for a movie (late afternoon), dinner (early evening) ana a club (late evening). In response, the interfacing agent may use its “filtering” processes to determine which movie, restaurant, and club best fits the user profile. This may be achieved by either scraping or using the APIs of a movie website (e.g. Fandango), a restaurant website (e.g., OpenTable), and a club website. The collected data may then be combined and passed onto another component for further filtering/processing (e.g., a scheduling component to schedule the times for each activity). Thus, data and subsets of the data collected from various sources may be filtered/processed, based on user preferences multiple times and in various ways to achieve a response that is appealing to the requesting user.

In another scenario, a group of friends want to schedule a set of activities (movie, restaurant, club). User A provides their agent with the information (e.g., a movie (late afternoon), dinner (early evening), and a club (late evening)) and names of user A's friends. User A's interfacing agent will communicate with the interfacing agents of user A's friends and gather details about the friends' preferences and flexibility. Based on the collected information, user A's interfacing agent may: 1) process the information; 2) collect and filter information from web service providers; 3) process the “filtered” information; 4) present the group with tentative plan options.

In one embodiment, the interfacing agent 206 may also include a request customization engine 242 that may change the request 236 from the user 204 using the user profile 232 to form a modified request. Thus, in one embodiment, the request customization engine 242 may modify the request 236 and retrieve more optimized response data 237 that would have been achieved using only the request 236. The request customization engine 242 may be used in addition to, or in lieu of, the filtering engine 238 to form user-customized response data for display to the user 204. When the request customization engine 242 is used in addition to the filtering engine 238, the response data 237 may be optimized using the modified request generated by the request customization engine 242 before the filtering engine 238 performs a filtering function, thereby providing at least two potential processes by which to customize data from the service providers 208 for a user.

In one embodiment, after receiving the request 236, the request customization engine 242 may change the request 236 of the user 204 using the user profile 232 to form a modified request that is sent to the service providers 208 or scrapers 209. The request customization engine 242 may change the request 236 using a first set of user attributes 234 of the user profile 232 to form the modified request. Upon receiving the response data 237 after sending the modified request to the one or more service providers 208 or scrapers 209, the filtering engine 238 may filter the response data 237 using a second set of user attributes 234 of the user profile 232 to form the user-customized response data presented to the user 204. The user attributes of the first set of user attributes 234 may differ from each of the user attributes in the second set of user attributes. In another example, there may be some overlap between the first and second sets of user attributes used by the request customization engine 242 and the filtering engine 238, respectively.

In a non-limiting example in which the interfacing agent 206 interfaces the user 204 to a search engine service provider, the request 236 may include one or more search terms that the request customization engine 242 changes into a set of modified search terms using the user profile 232. In one example, the request customization engine 242 may change the one or more search terms into the set of modified search terms by adding additional search terms to the one or more search terms inputted by the user 204, and the added search terms may be based on user attributes 234 in the user profile 232. The set of modified search terms may be sent, to one or more search engine service providers, which may return one or more search results to the interfacing agent 206 in the form of response data 237. The filtering engine 238 may then filter these one or more search results using the user profile 232 to form user-customized search results presented or displayed to the user 204.

By way of non-limiting example, the user 204 may input a request 236 that contains the search term “restaurant.” The user attributes 234 may indicate that the user 204 lives in Dallas and enjoys French cuisine. The request customization engine 242 may add the search terms “Dallas” and “French” to the original search term “restaurant”. The interfacing agent 206 may then send these search terms (“restaurant”, “Dallas”, and “French”) to the search engine service provider so that they may retrieve one or more search results that match the search terms. The search results may be sent back to the interfacing agent 206 in the form of response data 237. The filtering engine 238 may then receive these search results and further filter them based on another set of user attributes, such as the specific types of French cuisine that the user 204 likes or dislikes, as well as the areas of Dallas that the user 204 likes or dislikes, thereby further narrowing the search results received from the search engine service provider. These user-customized search results may then be presented to the user 204. The above-example also illustrates how different sets of user attributes may be used by each of the request customization engine 242 and the filtering engine 238.

The interfacing agent 205 may also interface the user 204 with a financial data service provider. For example, the user 204 may request, via the interfacing agent 206, certain financial information (e.g., stock data, market data, economic outlooks, etc.), and the interfacing agent 206 may analyze and/or filter the response data 237 received from the financial data service provider using the user profile 232 to present customized financial data to the user 204.

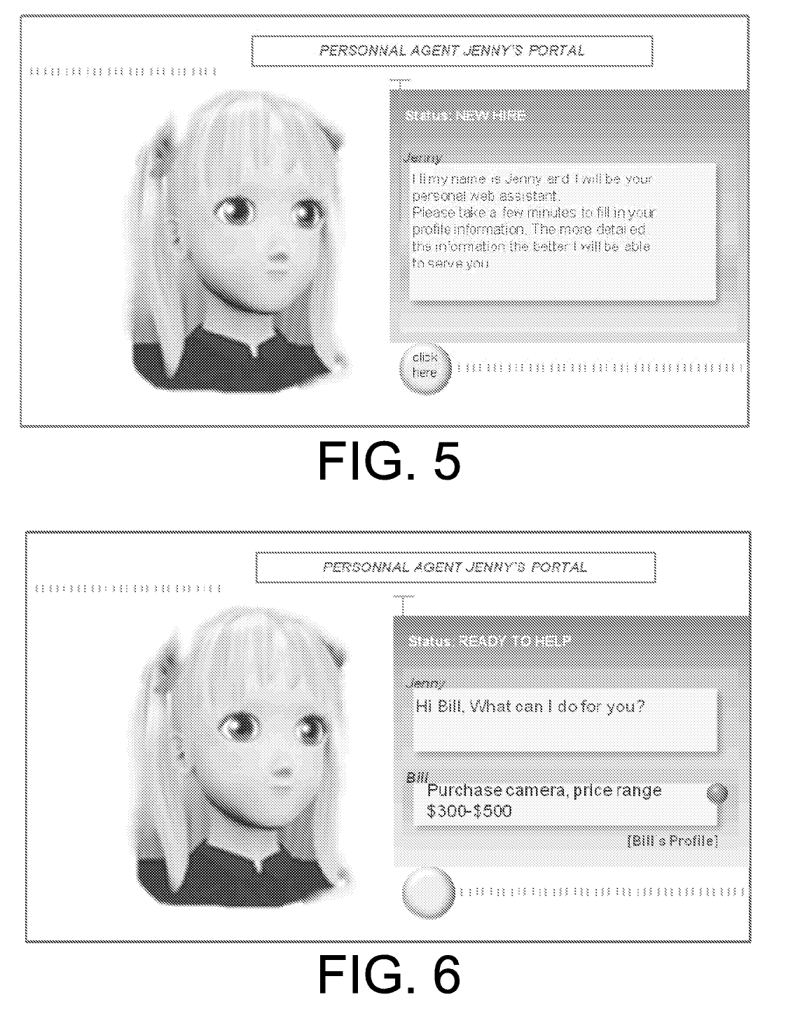

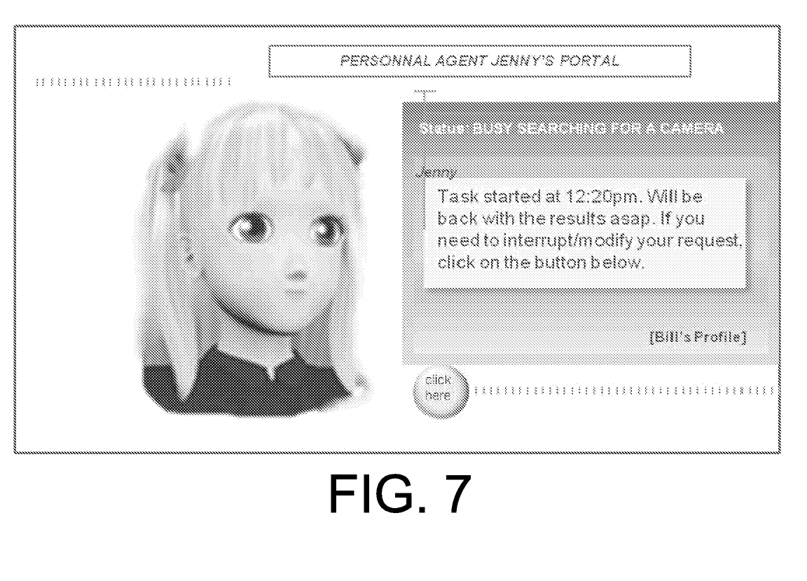

With reference to FIGS. 5 through 9, another illustrative embodiment of the operation of the interfacing system 200 is shown. In FIG. 5, a graphical user interface of the interfacing agent 206 greets the user 204, and prompts the user 204 to input his or her user attributes 234 so that the interfacing agent 206 may generate the user profile 232. In FIG. 6, the graphical user interface of the interfacing agent 206 prompts the user 204 to enter a request 236. In the example of FIG. 6, the user 204 inputs “Purchase camera, price range $300-$500”. It will be appreciated that the interfacing agent 206 may process numerous different types of requests, including textual requests, natural language requests, voice requests, etc. Voice requests may be spoken by the user 204, such as via the communication device interface 240 in the communication device 202, and received by the interfacing agent 206. After the user 204 inputs and submits the request 236, the graphical user interface of the interfacing agent 206 may display a status message and inform the user 204 that the interfacing agent 206 is processing the request 236, as shown in FIG. 7.

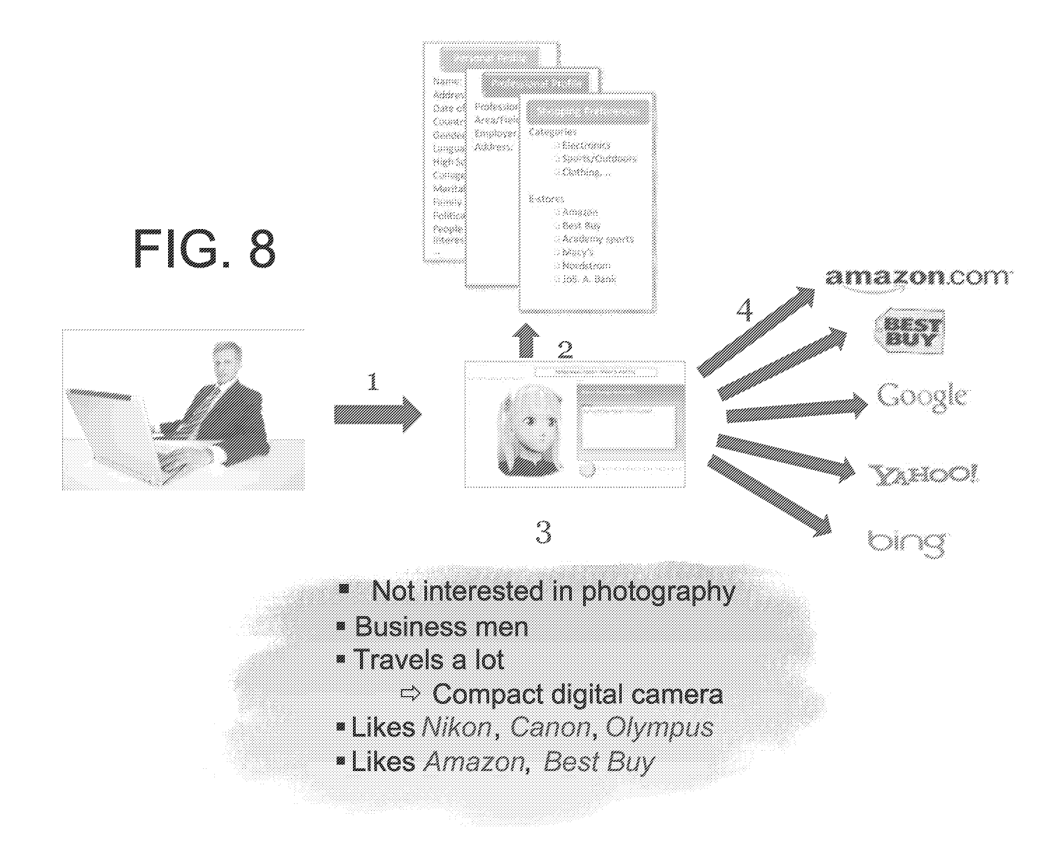

As shown in FIG. 8, the interfacing agent 206 may access the user attributes 234 in the user profile 232 to modify, improve, or otherwise process the original request 236 inputted by the user 204. Using the user profile 232, the interfacing agent 206 may determine that the user 204 (1) is not interested in photography, (2) is a businessman, (3) is a frequent traveler, and uses a compact digital camera, (4) likes Nikon®, Canon®, and Olympus® brand cameras, and (5) likes Amazon.com® and Best Buy® as vendors. Based on these user profile-based determinations, the interfacing agent 206 may customize the request 236, as well as determine the service providers 208 to which the request 236 is sent. Based on this processing by the interfacing agent 206, the customized request may be sent to one or more servi ce providers or scrapers. In the non-limiting example of FIG. 8, the customized request is sent to Amazon.com®, Best Buy®, Google®, Yahoo!®, and Bing® to search for a suitable camera.

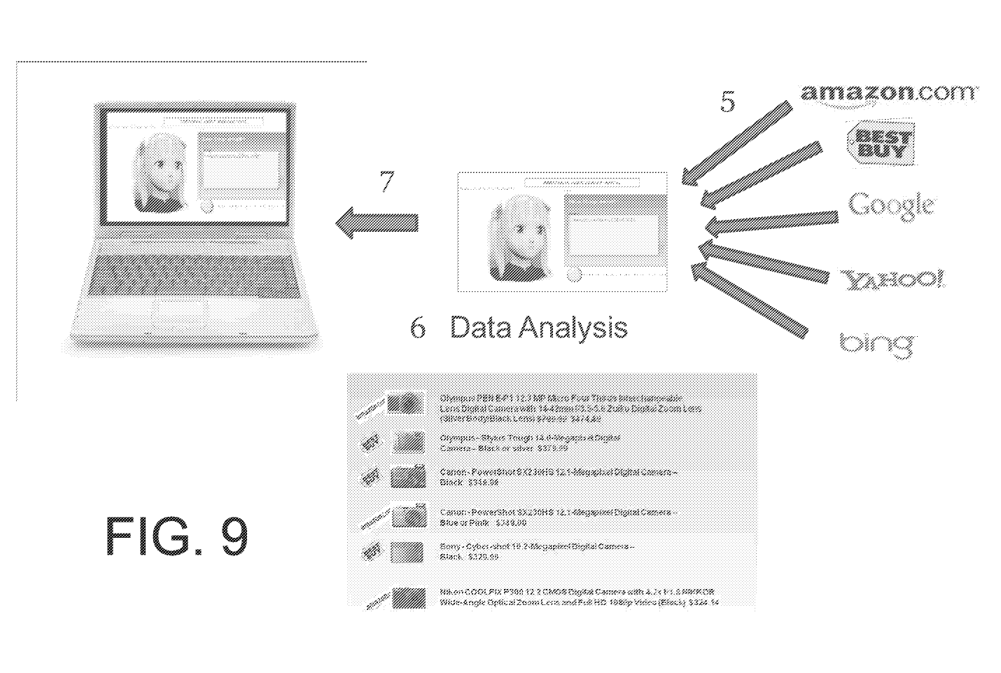

Referring to FIG. 9, the response data 237 sent back to the interfacing agent 206 from the service providers 208 or scrapers 209 may be filtered, including analyzed and/or processed, using the user profile 232 to generate the user-customized response data presented to the user 204. In the example of FIG. 9, the user-customized response data is a list of cameras from the service providers 208 that have been filtered by the interfacing agent 206. The user 204 may then browse the list of cameras and may have the ability to purchase one of the cameras in the list.

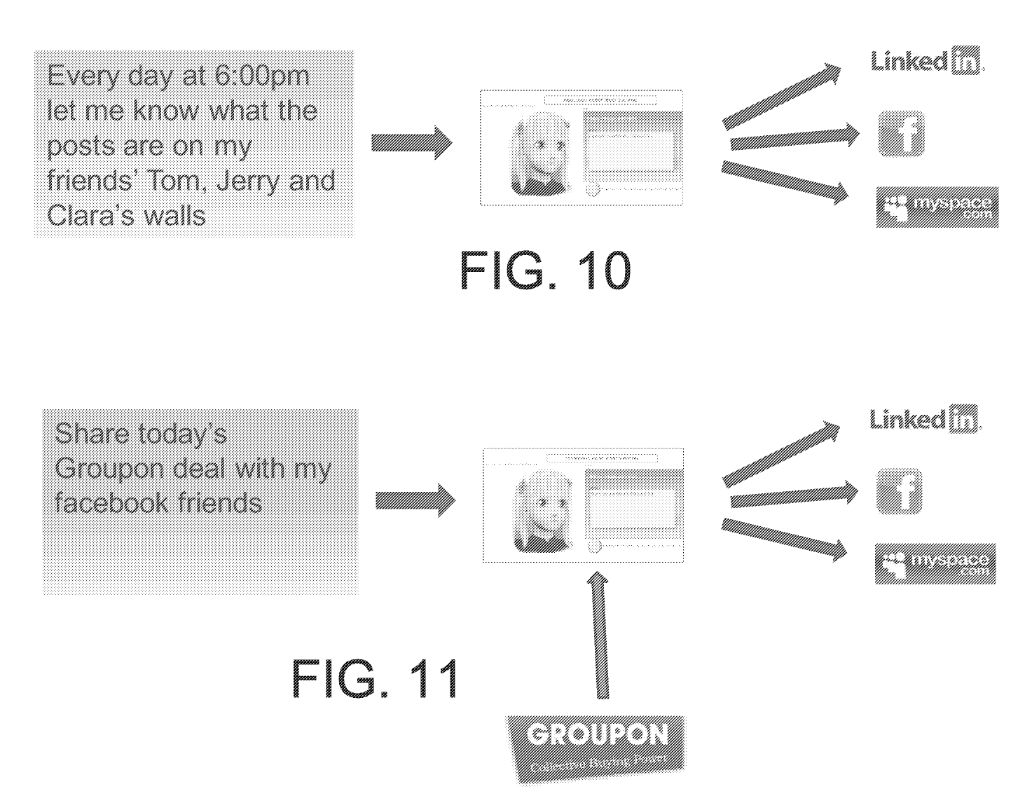

Referring to FIG. 10, another illustrative embodiment of the operation of the interfacing system 200 is shown in which the user 204 requests the interfacing agent 206 to inform, the user 204, every day at 6:00 pm, what posts are on the walls of the user's friends. The specific friends in the request may be defined by the user 204 (e.g., Tom, Jerry, Clara, etc.). The interfacing agent 206 may process this request by accessing the walls of the user's friends on one or more social, networking service providers (e.g., LinkedIn®, Facebook®, Myspace.com®, etc.). The posts that match the user's request may be presented by the interfacing agent 206 to the user 204.

Referring to FIG. 11, another illustrative embodiment of the operation of the interfacing system 200 is shown in which the user 204 requests the interfacing-agent 206 to share today's Groupon deal, or deals with the user's Facebook or social networking friends. In response to this request, the interfacing agent 206 may access Groupon to obtain the deal, and access one or more social networking service providers (e.g., LinkedIn®, Facebook®, Myspace.com®, etc.) so that the Groupon deal may be shared with the user's friends on these social networking service providers. The user 204 may opt to perform this sharing process on a periodic basis (e.g., daily, weekly, etc.).

In another embodiment, the interfacing agent 206 may interface the user 204 to other users by directly interfacing with one or more external interfacing agents 224, each associated with a respective user. As shown in FIG. 3, any number of interfacing agents 244, 246, 248, 250 may interface with one another via a data communication medium 252, such as the Internet. Each of these interfacing agents 244, 246, 248, 250 may be implemented or executed on a respective communication device 254, 256, 258, 260.

Returning to FIG. 2, any of the processes described above with respect to interfacing the user 204 to the service providers 208 or scrapers 209 may also be applied to interfacing the user 204 to the external interfacing agents 224. Interfacing users with one another via their respective interfacing agents 206, 244, 246, 248, 250 may allow the users to interact with one another, including interactions via applications executed by the interfacing agents 206, 244, 246, 248, 250. Communication, direct or indirect, between the interfacing agents 206, 244, 246, 248, 250 may also allow users to search for other users based on the user profiles stored in their respective interfacing agents 206, 244, 246, 248, 250.

In one embodiment, the interfacing agent 206 may send the request 236 to one or more external interfacing agents 224, each of which may be associated with a respective user profile for a respective user. The request customization engine 242 may change the request 236 to a modified, request, as described above. Upon receiving the response data from the one or more external interfacing agents 224, the filtering engine 238 may filter the response data using the user profile 232 to form user-customized response data, as described above. The user-customized response data may then be presented to the user 204 on the communication device interface 240.

In one embodiment, the filtering engine 238 may filter the response data from the one or more external interfacing agents 224 by comparing the user profile 232 of the user 204 to the one or more respective user profiles for the one or more respective users associated with the one or more external interfacing agents 224. The filtering engine 238 may determine the user-customized response data presented to the user 204 based on this comparison.

In another embodiment, the user 204 may request user-identifying data for one or more users associated with the external interfacing agents 224. For example, the user 204 may request identifying data for users of the external interfacing agents 224 that have similar interests, a compatible lifestyle, a similar occupation, potential clients, etc. The interfacing agent 206 may compare the user profile 232 of the user 204 with the user profiles stored in the external interfacing agents 224 to determine which of the respective users associated with the one or more external interfacing agents 224 best matches or fits the user's request 236. In one example, user-identifying response data may be sent from the external interfacing agents 224 to the interfacing agent 206, including data from the user profiles of the respective users of the external interfacing agents 224, so that such a comparison may be made. The filtering engine 238 may filter the user-identifying response data from the external interfacing agents 224 using the user profile 232 to form or generate user-customized user-identifying data that is presented to the user 204. The user-customized user-identifying data that is presented to the user 204 may include the names, or other identifying information, of users that match, or best respond to, the user's request 236. The interfacing agent 206 may interface the user 204 with the respective users that are identified in the user-customized user-identifying data using a data communication medium, such as the data communication medium 252, between the respective interfacing agents 206, 244, 246, 248, 250.

In an alternate embodiment, the interfacing agent 206 may act as a toy or gaming platform. For example, the interfacing agent 206 may implement an application that requires caretaking by the user 204, such as a virtual child or animal; such applications may also be able to interact with one another to include more than one user. In another embodiment, the user 204 may be an employee or dependent of an administrator of the interfacing agent 206, and the administrator may make the interfacing agent 206 available for use by the user 204 to increase his or her productivity, efficiency, or other goals.

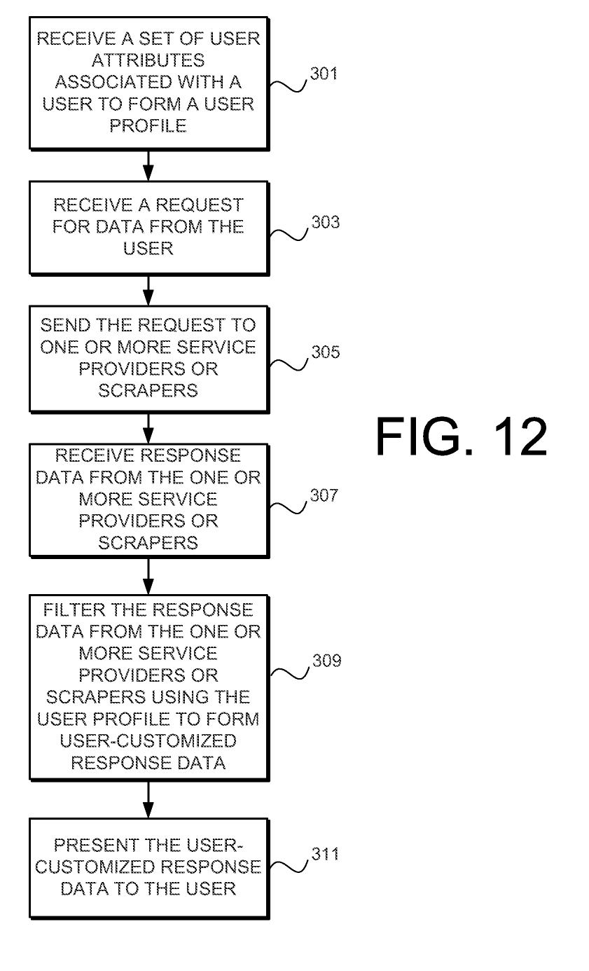

Referring to FIG. 12, an illustrative embodiment of a process for interfacing the user to service providers, which may be implemented by an interfacing agent, such as the interfacing agents 106, 206 in FIG. 1 or 2, includes receiving a set of user attributes associated with a user to form a user profile (step 301). The process receives a request for data from the user (step 303). The process sends the request to one or more service providers (step 305). In one embodiment, this request to a service provider may also be sent to and handled by a scraper, such as when a service provider does not have an API. The scraper may “scrape” websites to collect data needed for the interfacing agent to make decisions based on the user request. The process may then receive response data from the one or more service providers or scrapers (step 307). The process filters the response data from the one or more service providers using the user profile to form user-customized response data (step 309). The process presents the user-customized response data to the user(step 311).

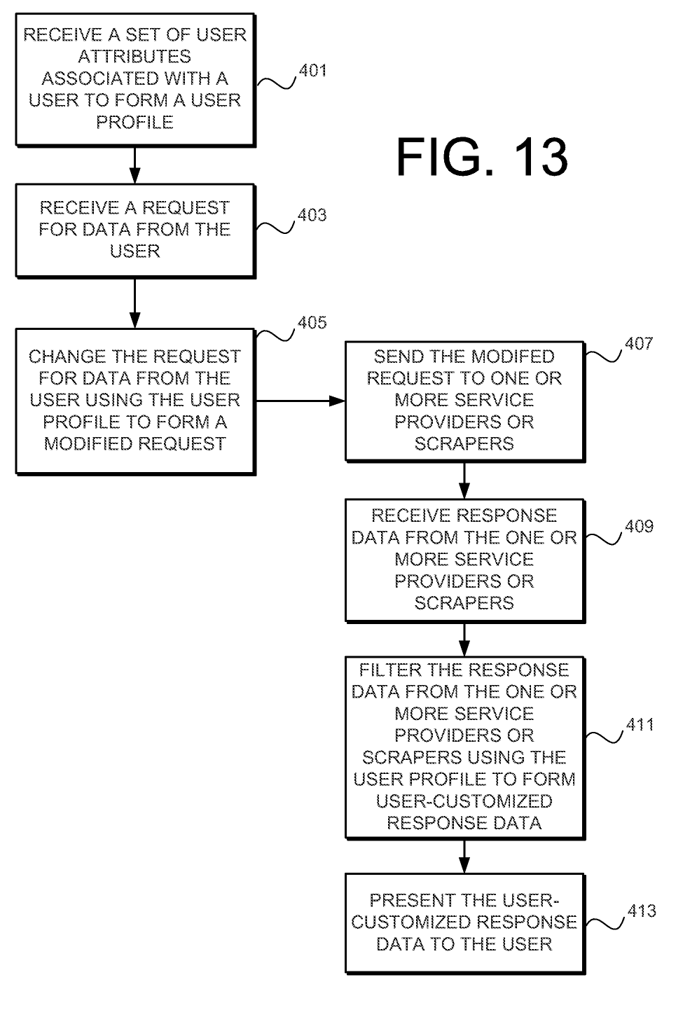

Referring to FIG. 13, an illustrative embodiment of a process for interfacing a user to service providers, which may be implemented by the interfacing agents 106, 206 in FIG. 1 or 2, includes receiving a set of user attributes associated with the user to form a user profile (step 401). The process receives a request for data from the user (step 403). The process changes the request for data from the user using the user profile to form a modified request (step 405). The process sends the modified request to one or more service providers (step 407). In one embodiment, this request to a service provider may also be sent to and handled by a scraper, such as when a service provider does not have an API. The process receives response data from the one or more service providers (step 409). The process filters the response data from the one or more service providers using the user profile to form user-customized response data (step 411). In one embodiment, the user attributes used to change the request into the modified, request in step 405 may be fully or partially different than the user attributes used to filter the response data in step 411. The process presents the user-customized response data to the user (step 413).

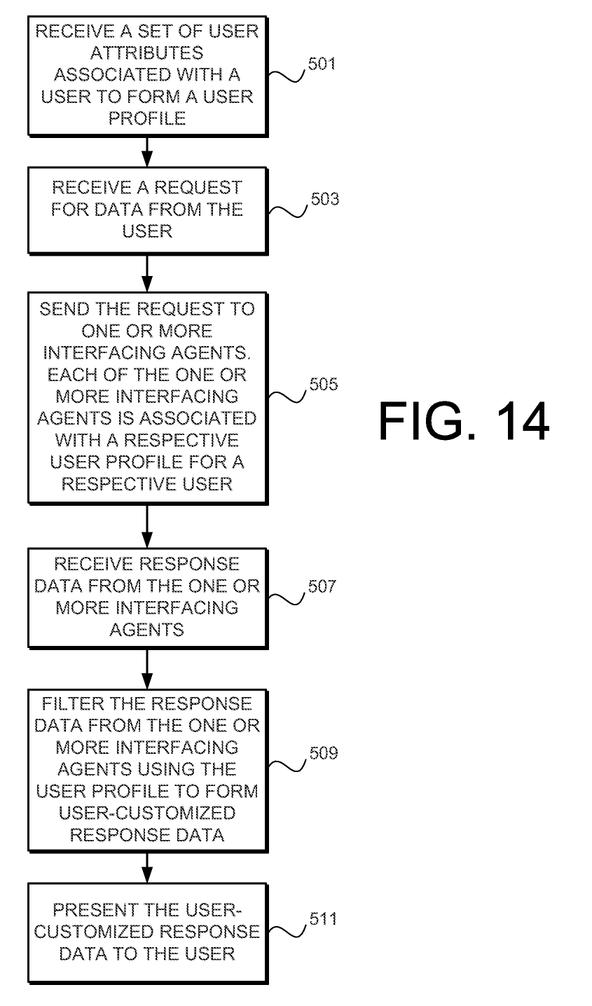

Referring to FIG. 14, an illustrative embodiment of a process for interfacing a user to other interfacing agents, which may be implemented by the interfacing agents 106, 206 in FIG. 1 or 2, includes receiving a set of user attributes associated with the user to form a user profile (step 501). The process receives a request for data from the user (step 503). The process sends the request to one or more interfacing agents (step 505). Each of the one or more interfacing agents is associated with a respective user profile for a respective user.

The process receives response data from the one or more interfacing agents (step 507). The process filters the response data from the one or more interfacing agents using the user profile to form user-customized response data (step 509). The process presents the user-customized response data to the user(step 511).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

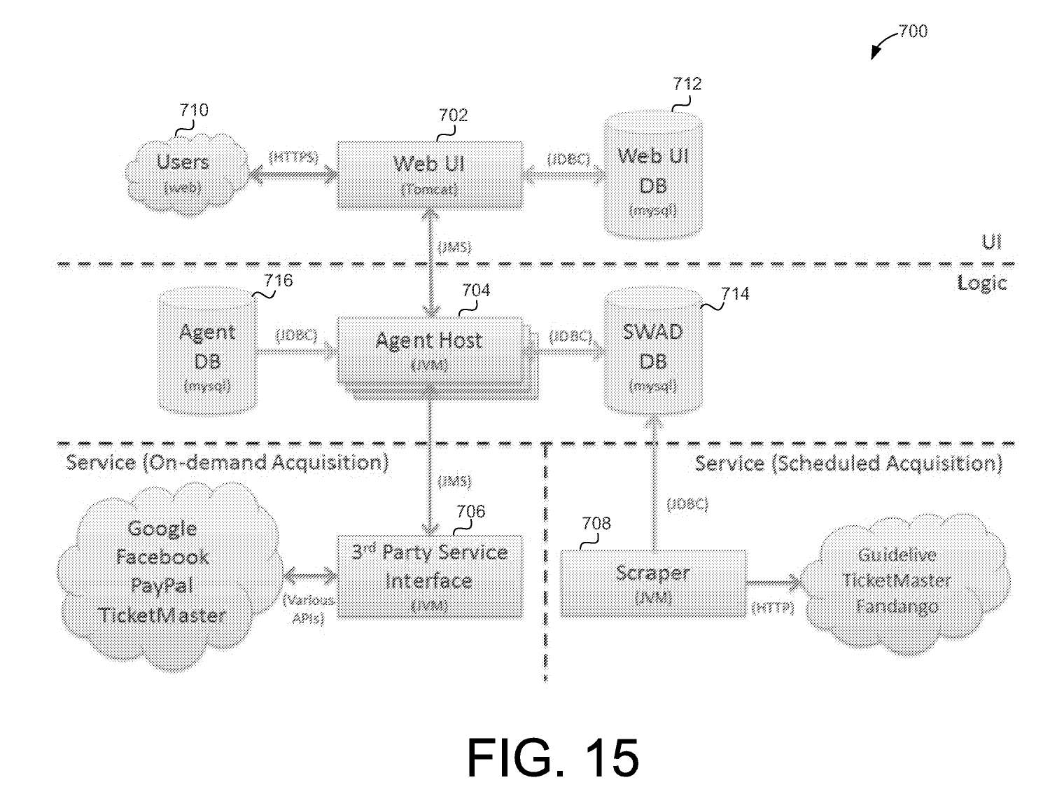

FIG. 15 is a schematic, pictorial representation of an example architecture of an interfacing system according to an illustrative embodiment. The interfacing system may, as described above, provide user-customized responses to user requests for data. In this illustrative example, interfacing system 700 is shown to comprise four main subsystems: a web user interface 702, an agent host 704, a third party interface service 706, and a data acquisition service 708. It should be noted, however, that the interfacing system 700 is meant only as an example and not intended as a limitation on different illustrative embodiments. In other words, interfacing system 700 may include more or fewer subsystems as necessary to accomplish processes of the different illustrative embodiments.

The web user interface (web UI) 702 provides users with a web-based graphical user interface for interacting with the system and requesting data from service providers. In particular, web user interface 702 may provide an interface for a user to interact with its user, or interfacing, agent. In one embodiment, the web user interface 702 may comprise a Tomcat web server that is in communication with a user 710, a web UI database 712, and an agent host 704. The web user interface 702 acts as a presentation layer and may be initially responsible for authenticating users. For example,the user 710 may utilize a web browser to communicate with the web user interface 702 via a communication protocol such as Hypertext Transfer Protocol (HTTP). The web user interface 702 may receive the user's 710 logon request and authenticate the user 710. This authentication may comprise various authentication measures, including, for example, internal interface authentication as well as external interface authentication. For instance, the web user interface 702 may authenticate the user to the “internal” user interface system by retrieving information from web UI database 712, which stores information concerning the web user interface 702 (including login credentials, color schemes, layouts, etc.), and then authenticating the user's credentials. The web user interface 702 may also authenticate the user to an “external” user interface (e.g., Facebook, Google, or OpenID providers, etc.) by authenticating the user-supplied credentials with the external, third-party site.

Once logged in to the web user interface 702, the user 710 may use the web user interface 702 to submit requests for data to one or more service providers. In interacting with the user 710, the web user interface 702 may provide a visual representation of the user's agent, or “eMe”, to the user 710. In one embodiment, interactions and requests for information that occur between the user 710 and the user's agent representation may be communicated to the user's agent in the agent host 704 via Java Messaging Service (JMS). When user requests are handled and fulfilled by the user's agent in the agent host 704, the user's agent sends its response back to the web user interface 702 to display to the user 710.

In one embodiment, the agent host 704 is an example of the interfacing agent 206 in FIG. 2. Although only one agent host is shown in this illustrative example, any number of agent hosts may be employed in accordance with the number of users and the needs of the interfacing system. The agent host 704 manages or hosts user agents and service agents, and is responsible for executing the users' agents ana service agents as needed. The user agents may act as the primary decision-makers for the system. Each user agent may act on behalf of its user. For example, a user may make a request to its user agent (eMe), and the user agent may send or relay the request to one or more service providers. In response, the service providers may send response data back to the user's agent, which may then filter the response data based on the user profile of the user 710 to form or generate response data customized to that user.

In one embodiment, service agents may be specialized agents that manage non-decision-critical work for the user agents. Each service agent may be trained to perform a particular task, thus allowing user agents to focus primarily on making decisions. User agent data may be stored within and may be retrieved from agent database 716. Service agent data may be stored within and may be retrieved from scheduled web acquisition database (SWAD) 714.

The agent host 704 may comprise various internal interfaces for communicating with the web user interface 702, third party service interface 706, agent database 716, and SWAD database 714. For instance, the agent host 704 may interact with the web user interface via JMS. In addition, the agent host 704 may initiate an interaction with the third party service interface via JMS for third party service requests. The third party services may include social networks, scheduling, reservations, and payments, among others. Also, the agent host 704 may interact with the agent database 716 via JDBC. The agent host 704 may read and write user preferences and agent parameters to and from the agent database 716. When activated, the agent host 704 may load the agent's state from the agent database 716. When an agent instance is deactivated, its state may be persisted in the agent database 716. Further, the agent host 704 may interact with the SWAD database 714 via JDBC. The agent host 704 may query activity information from the SWAD DB 714.

The third party service interface 706 may comprise a collection of libraries that provide service agents an interface for interacting with third party services and data sources. The third party service interface 706 may handle implementation-specific tasks for each of the third party services and provide service agents with abstracted interfaces for interacting with these services. Service agents may use these libraries to interact with third party services as needed to fulfill user requests and provide on-demand acquisition of data.

Due to the high frequency of change in third party service APIs, it may be necessary to create a layer of abstraction for service agents to interact with these APIs. The third party service interface libraries may implement specific third party service APIs and provide service agents with an abstract interface, thus isolating service agents from the volatility of third party service APIs. Service agents may use the third party service interface libraries directly.

As new third party services are needed or become available, the services may be integrated into the interfacing system 700 by first creating a third party service interface library implementation. Once the third party service interface library implementation is created, service agents may be trained to utilize the service. Consequently, user agents may then be able to use the third party services provided such that the user agents may make more informed decisions as they become more integrated into the user's digital services (e.g., online calendars, social networks, etc.)

The third party service interface 706 may provide an internal interface to the agent host 704; the third party service libraries may be used by service agents in the agent host 704 to assist in fulfilling user agent requests. The third party service interface 706 may also provide an interface to external third party service providers, including, for example, Google Calendar, Google Maps, Facebook, PayPal, Ticketmaster, Open Table, etc.

The web user interface 702, agent host 704, and third party service interface 706 may communicate via a reliable, asynchronous Java Message Service (JMS) implementation. JMS allows a high volume of messages to be transferred locally or over a network. JMS uses a message broker to handle the routing and delivery of messages, thus components are not required to know the exact location of the desired message recipients. This enables the system to be widely distributed in order to handle large numbers of active users and future capabilities. However, in other embodiments, other communication techniques, languages, or standards may be utilized.

The scraper 708 comprises a library of Java programs that intelligently acquire publicly-available data from other websites and web services. In one embodiment, the scraper 708 is a collection of Java classes that “scrape” websites for information needed for user agents to make decisions based on user requests. The scraper 708 may retrieve information from external sources (websites and databases) and store the information in the SWAD database 714 for use by the agents. The scraper 708 may run automatically at scheduled intervals (scheduled acquisition).

The scraper 708 may provide an internal interface to the SWAD database 714; the scraper 708 may communicate with the SWAD database 714 via JDBC to store the scraped data in and retrieve it from the database. The scraper 708 may also provide an interface to external third party service providers, including, for example, Guidelive (HTTP), Ticketmaster (affiliate API), Fandango (affiliate widgets HTTP), Yelp (affiliate API), etc.

When additional external data sources are discovered and become accessible, the Java class responsible for scraping and acquiring the data may only need to be registered to the scraper 708. Developers may create or extend an existing database table to store the new data set and choose what frequency the data source should be accessed. Once stored, the data is accessed to the user agents and can be used in making more informed decisions.

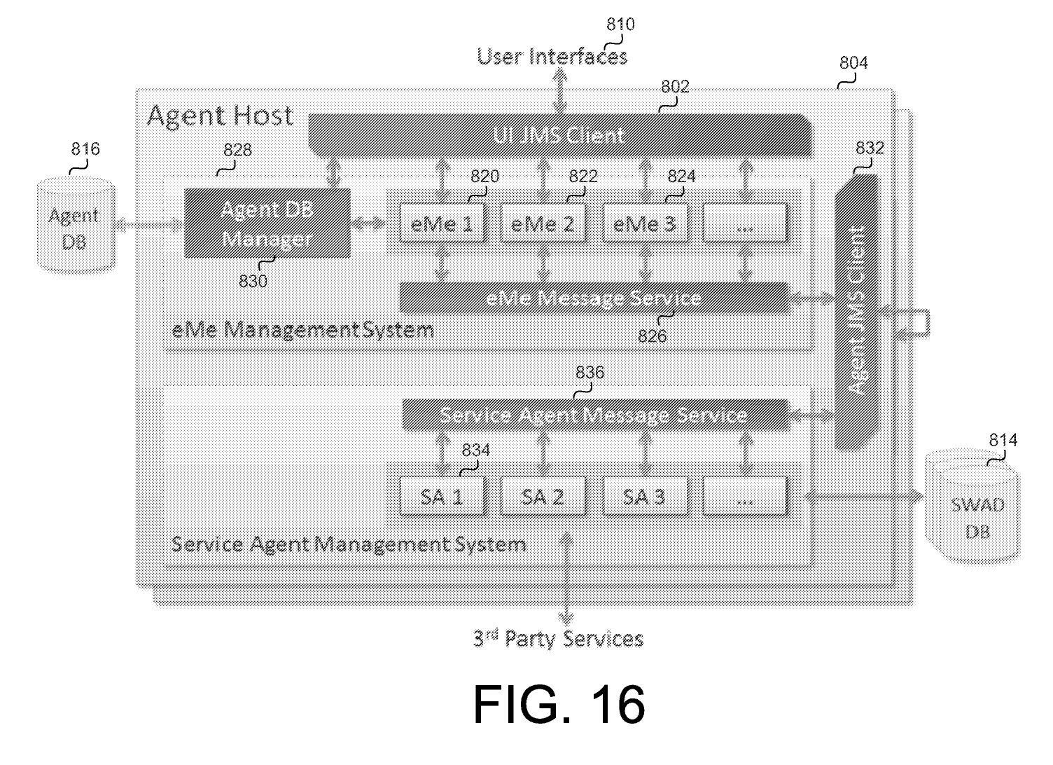

FIG. 16 is a schematic, block diagram of an exemplary agent host according to an illustrative embodiment. Agent host 804 is a detailed example of agent host 704 in FIG. 15.

The agent host 804 provides a multi-agent-based subsystem responsible for executing users' agents (eMes) and service agents. The number of user agents present may be determined by the number of active users and service agents, and this number may be adjusted automatically to accommodate usage fluctuations. Each user may be assigned a single agent (or “eMe” 820), created during runtime, that makes decisions and suggestions based on its user's preferences. The eMe 820 may be trained to make decisions based on a collection of algorithms. When a user makes a request, the eMe 820 may employ one or more of these algorithms, considering preference data associated with the requesting user, other users' eMes (e.g., 822, 824), and service agents, to make decisions and ultimately fulfill the request.

Since an example task of eMes is to make decisions for their user, service agents may be given the responsibility of gathering third party information and performing basic tasks, such as scheduling, searching, etc. By delegating these basic tasks to the service agents, the eMes 820-824 are able to focus on decision making. Unlike eMes, which are singularly assigned to users, there may be multiple service agents trained to perform a specific task.

In one embodiment, a user's eMe may only be active when the user is logged in or when it is needed by another eMe. When an eMe is active, its current knowledge is maintained in the agent database 816. This fail-safe mechanism ensures that if an eMe were to stop unexpectedly, its knowledge would not be lost. Thus, prior to becoming inactive, an eMe may save its user's preference information to the agent database 816. The user's eMe runtime instance may then be deleted and its system resources reclaimed for other active agents. When an eMe is needed again, a new eMe instance may be created based on the preferences stored in the agent database 816.

Remote agents (eMes and service) may communicate with each other via a JMS connection. An agent host may comprise a messaging service 826 that handles communication with remote hosts, and communication with remote agents may be transparent. Thus, in one embodiment, an agent may communicate with remote agents in exactly the same manner as locally-hosted agents.

To illustrate the high-level workings of the user agents (eMes), consider a scenario where a user logs in to the web user interface and requests that the user's eMe provide movie recommendations. The user enters his or her credentials via the user interface (web, mobile, or other). The login request is received by the web user interface JMS client 802 and forwarded to the eMe management system 828. If the eMe management system 828 determines that the user's eMe is not active, it may inform the agent database manager 830 to retrieve the eMe's basic information from the agent database 816. The eMe management system 828 may use the retrieved information to activate the user's eMe, then inform the web user interface 810 that the eMe is ready to serve the user.

The user may then request movie recommendations via the web user interface 810. The request may be received by the web user interface JMS client 802 and delivered directly to the user's eMe 820 (which is now active). The eMe may process the request and determine that it requires additional information from a movie listing service agent to fulfill the request. The eMe may send a movie listing request to a movie listing service agent over the agent JMS client 832 via the service agent message service 836. The first available movie listing service agent 834 may retrieve a list of movies from the SWAD database 814 and return the list to the eMe 820. The eMe 820 may sort through the movie list and determine which movies its user is most likely to enjoy based on the user's known preferences and past decisions. The eMe 820 may send the list of recommended movies back to the web user interface 810 for the user to view.

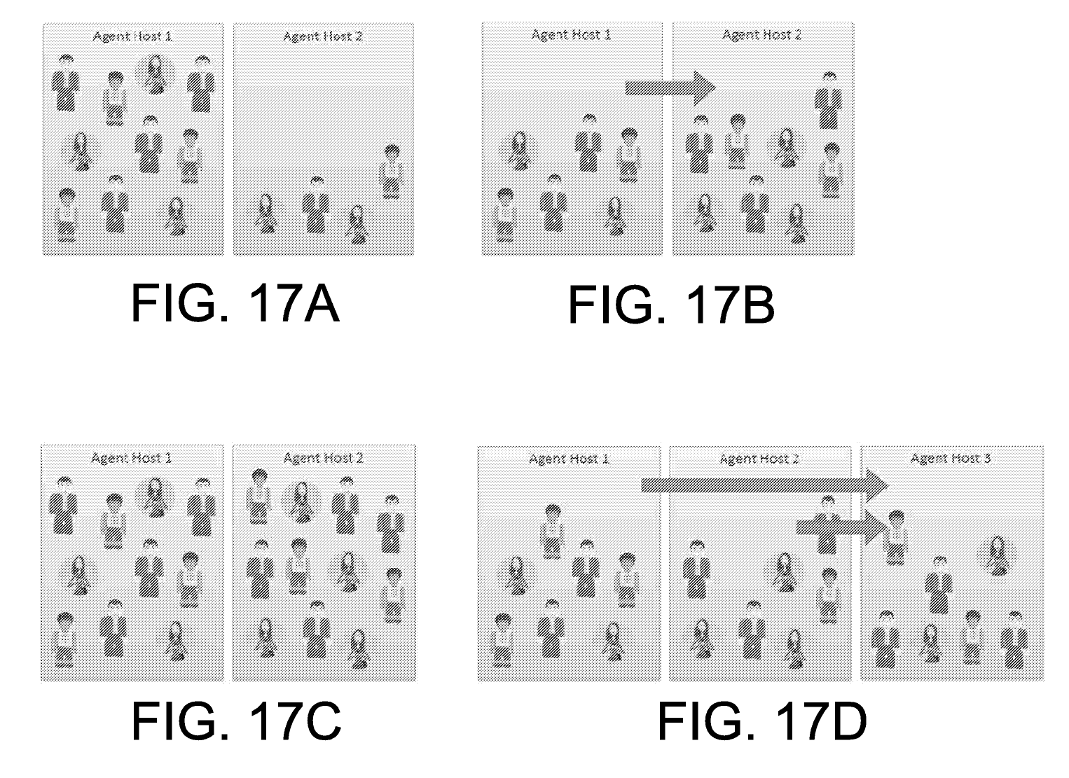

FIGS. 17A-17D are schematic, pictorial representations of agent host delegations according to an illustrative embodiment. The interfacing systemmay provides a self-scaling mechanism to enable the number of user agents (eMes) to be adjusted automatically to accommodate usage fluctuations.

The system is comprised of one or more agent hosts as necessary to support the current load of user agents. In other words, the number of agent hosts present may be determined by the number of active users. In one embodiment, each agent host may reside in a server. The agent hosts may monitor their own performance and delegate work as needed to ensure that user requests are handled promptly. Since agents (eMes and service agents) are the primary workers, agent hosts may delegate work by migrating agents to other, less utilized, agent, hosts. For example, FIG. 17A shows a particular situation in which agent host 1 is approaching over-utilization. As agent host 2 is under-utilized, the interfacing system may take action to relieve the situation by delegating agents from agent host 1 to agent host 2, as shown in FIG. 17B. Thus, a subset of user agents from the over-utilized agent host on one server (or server instance) may be migrated to another less-utilized agent host on another server (or server instance).

In contrast, when all agent hosts are approaching over-utilization, the agent hosts may activate or create new agent hosts to help support the workload. For example, FIG. 17C illustrates a particular situation in which both agent hosts 1 and 2 are approaching over-utilization. In this case, the interfacing system may alleviate the situation by having agent host 1 spawn new agent host 3. Agent hosts 1 and 2 may then delegate or migrate several agents to agent host 3. Thus, a subset of user agents from the over-utilized agent hosts may be migrated to a new agent host on another server (or server instance).

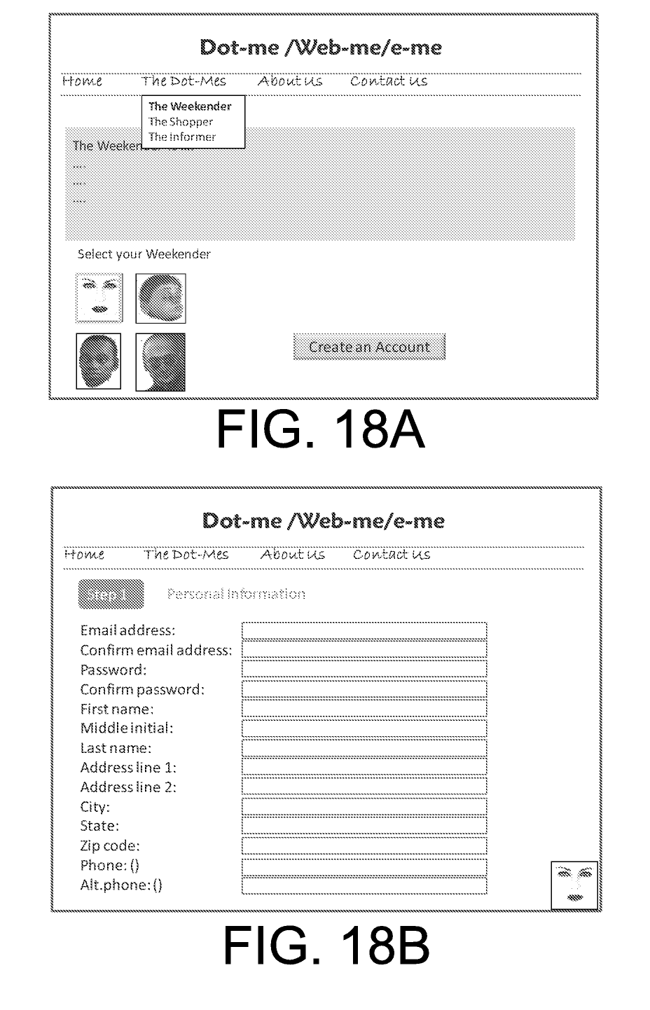

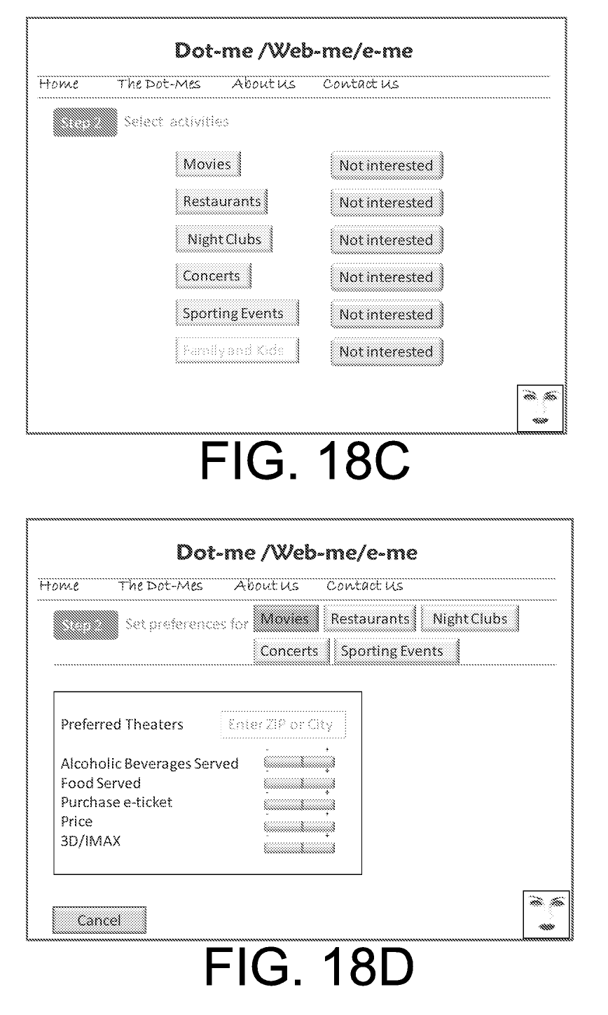

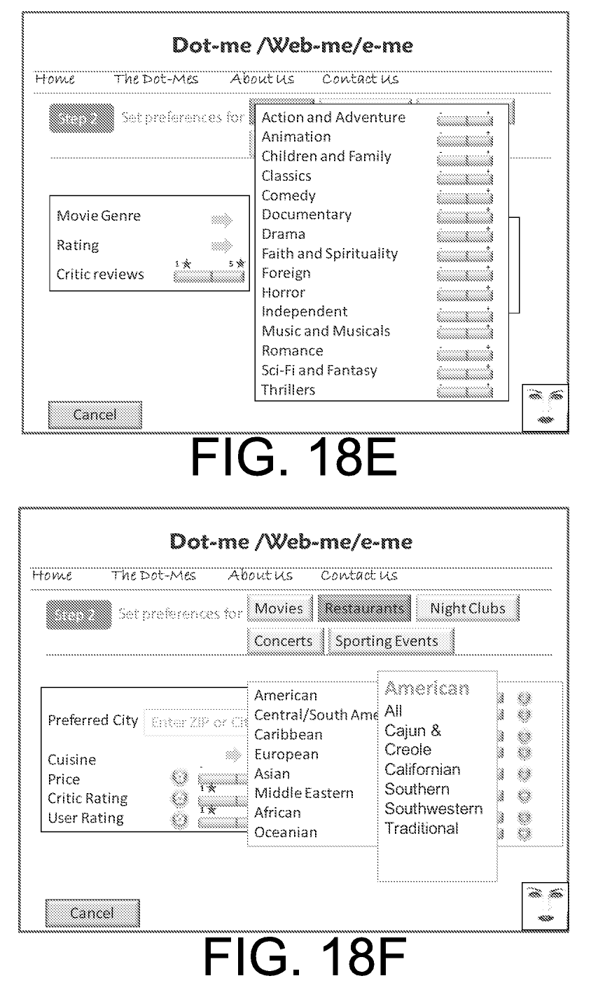

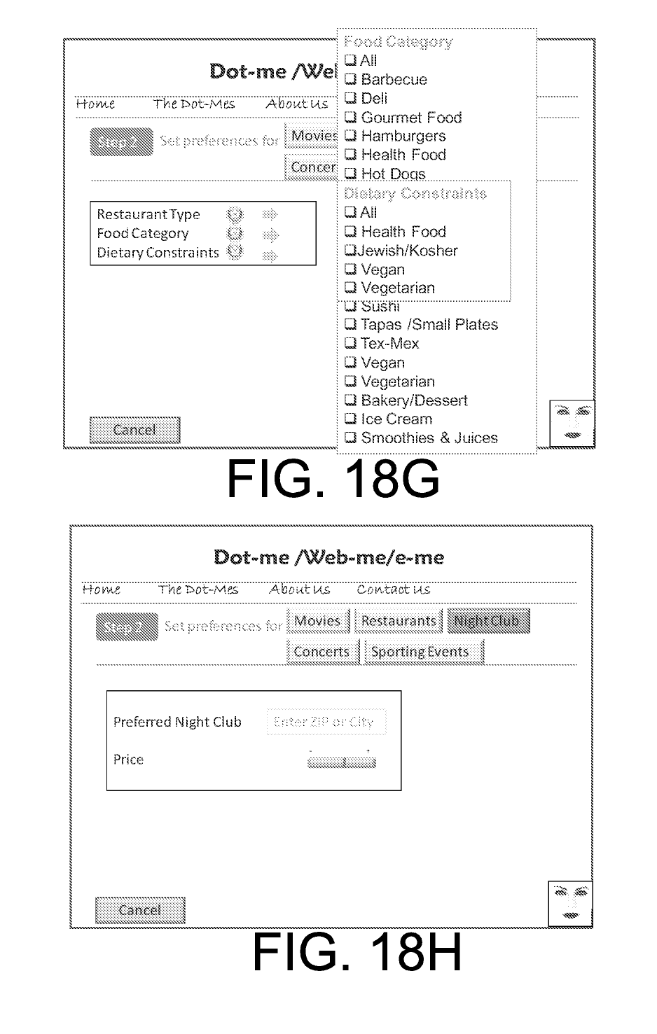

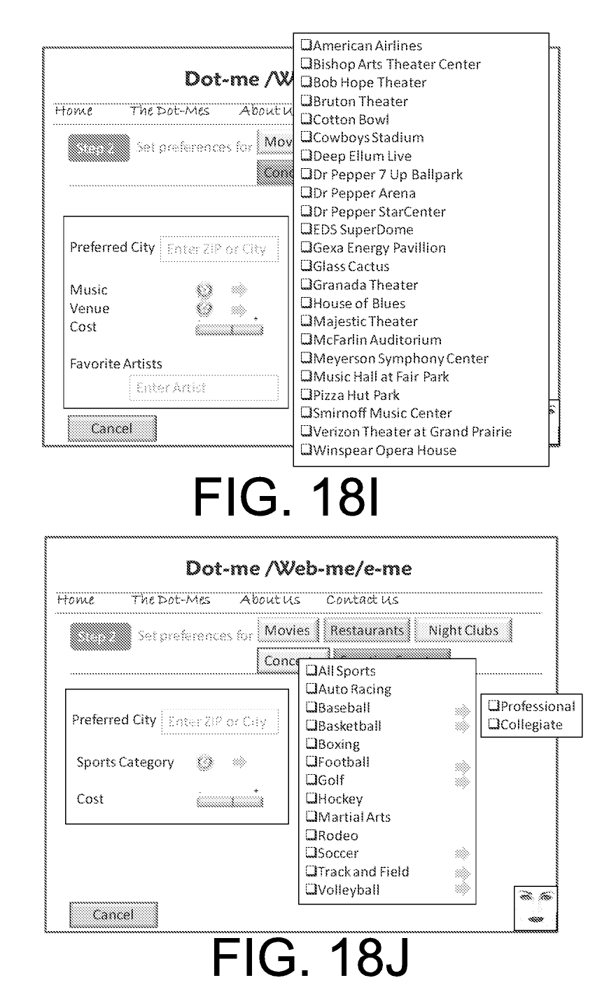

FIGS. 18-21 illustrate screenshots of example interactions between the interfacing system and users. In particular, FIGS. 18A-18J provide pictorial representations of example graphical user interfaces for creating user accounts and setting preferences according to an illustrative embodiment. In this example, the user may create an account as shown in FIGS. 18A-B, and also input information to generate a user profile for items or events. For instance, the user in this example has created an account for weekend activities (i.e., Weekender), and has defined the user's preferences for movies, restaurants, and nightclubs. The user may update or change the information in the user profile at any time.

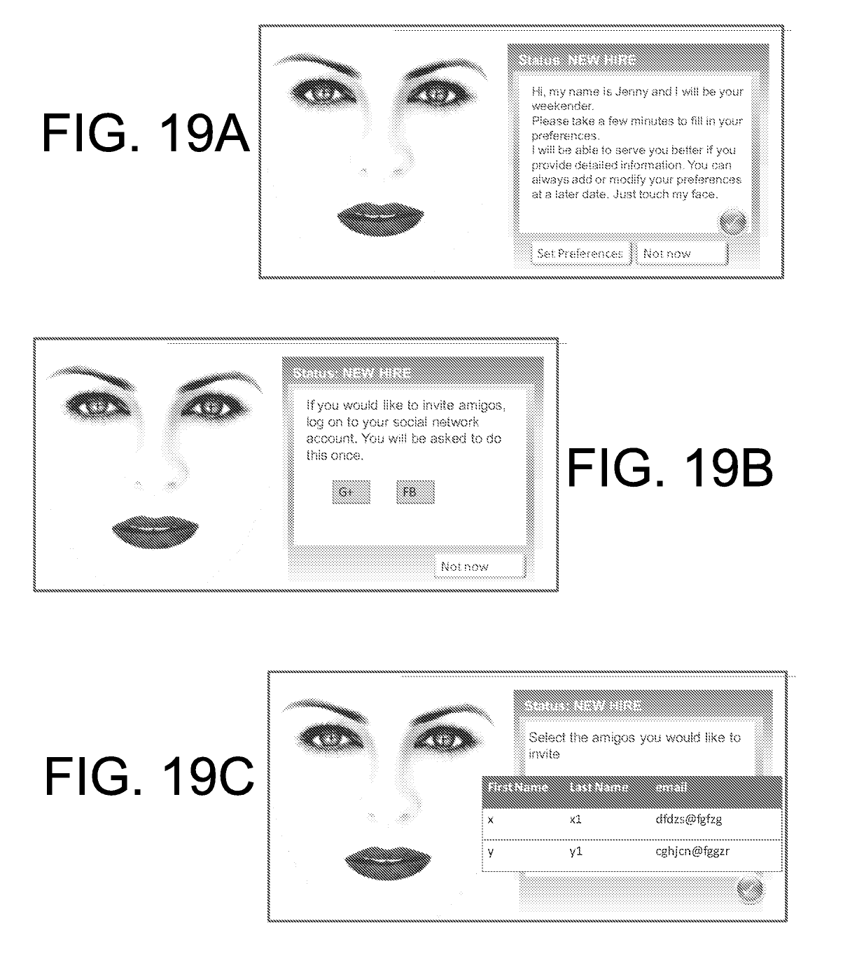

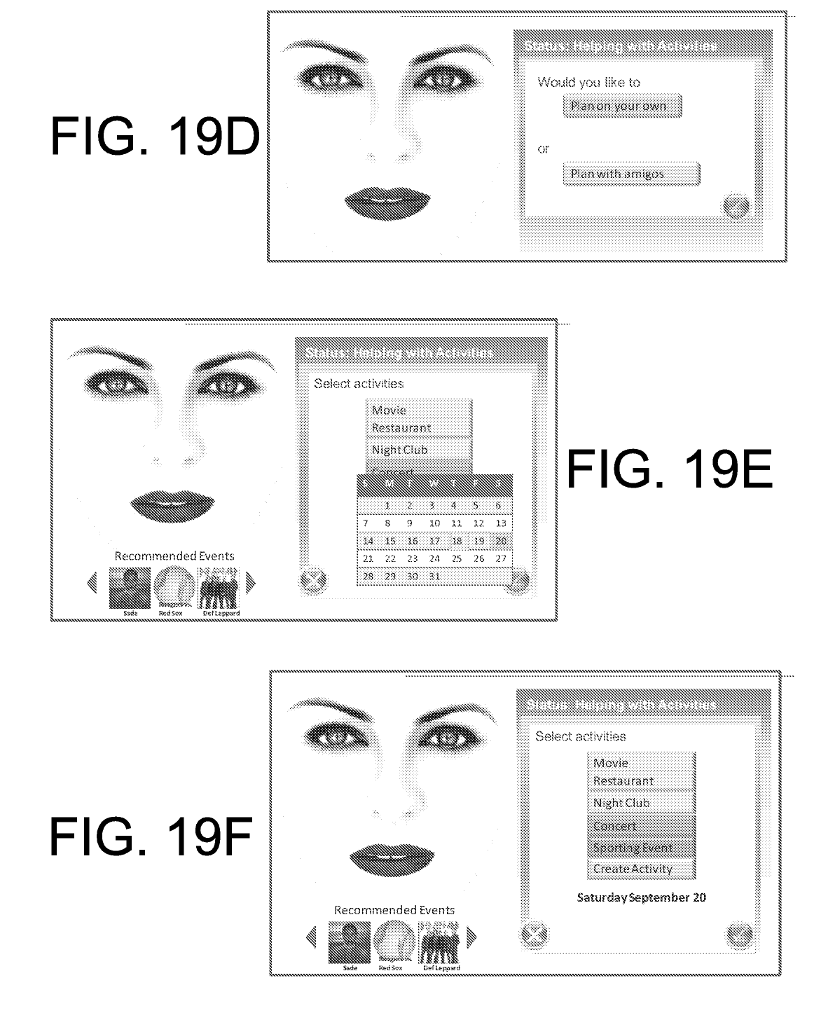

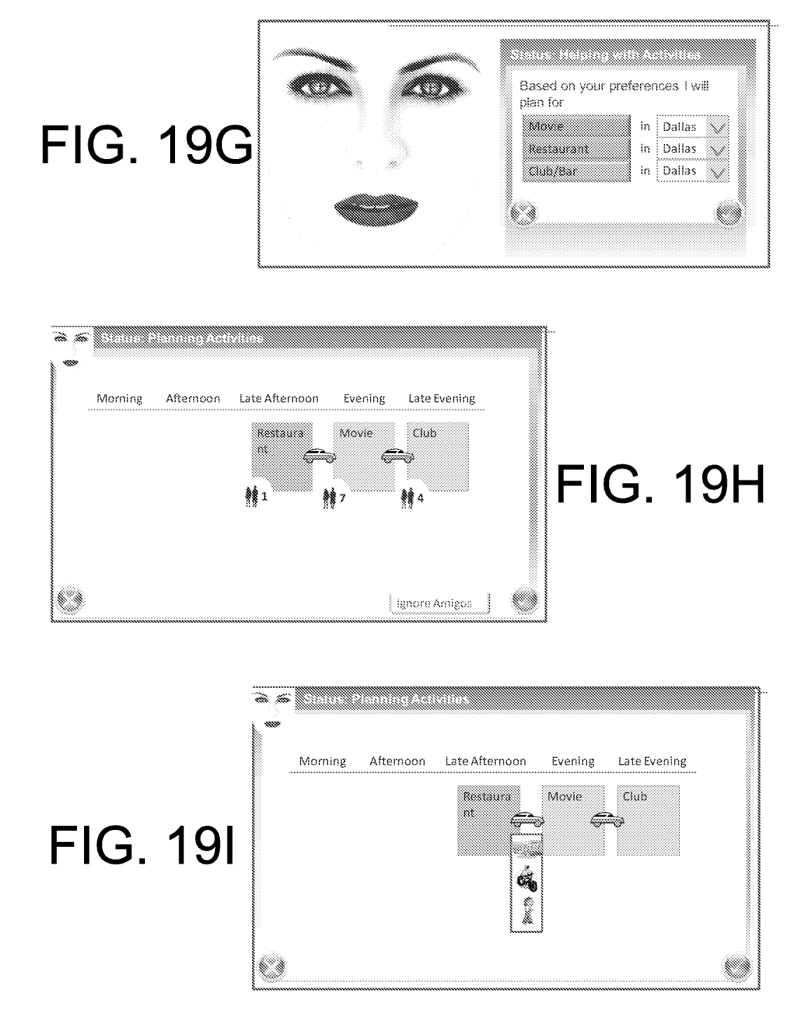

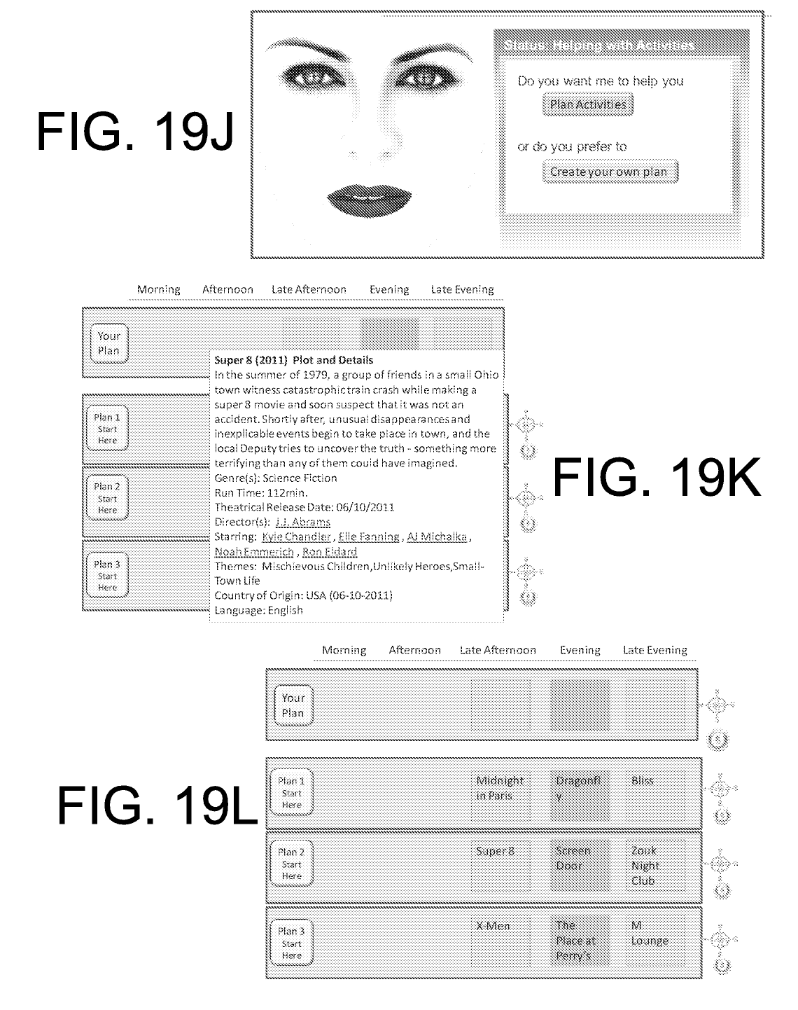

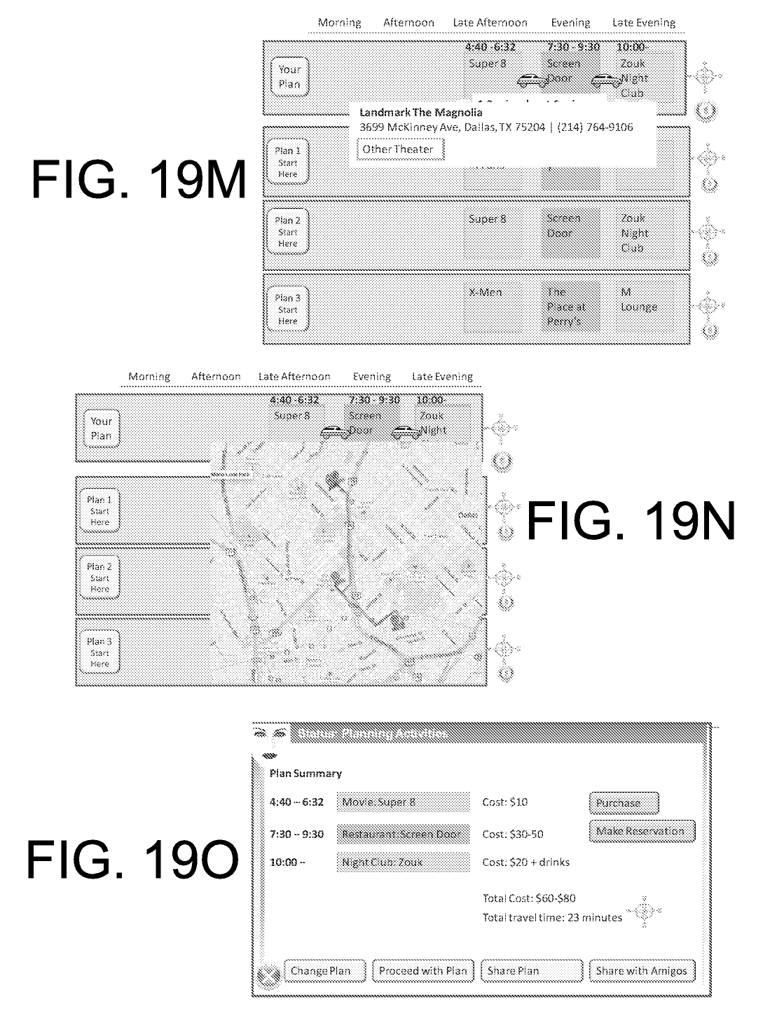

FIGS. 19A-19O provide screenshots of example graphical user interfaces for scheduling user activities according to an illustrative embodiment. In this example, a user's eMe interacts with the user to request that the user log on to the user's social media sites to enable the user to invite or plan events with other social media users. FIGS. 19A-O also illustrate how a user may schedule activities, and the interface system interacts with the user to provide information from service providers that is customized based on the user's preferences.

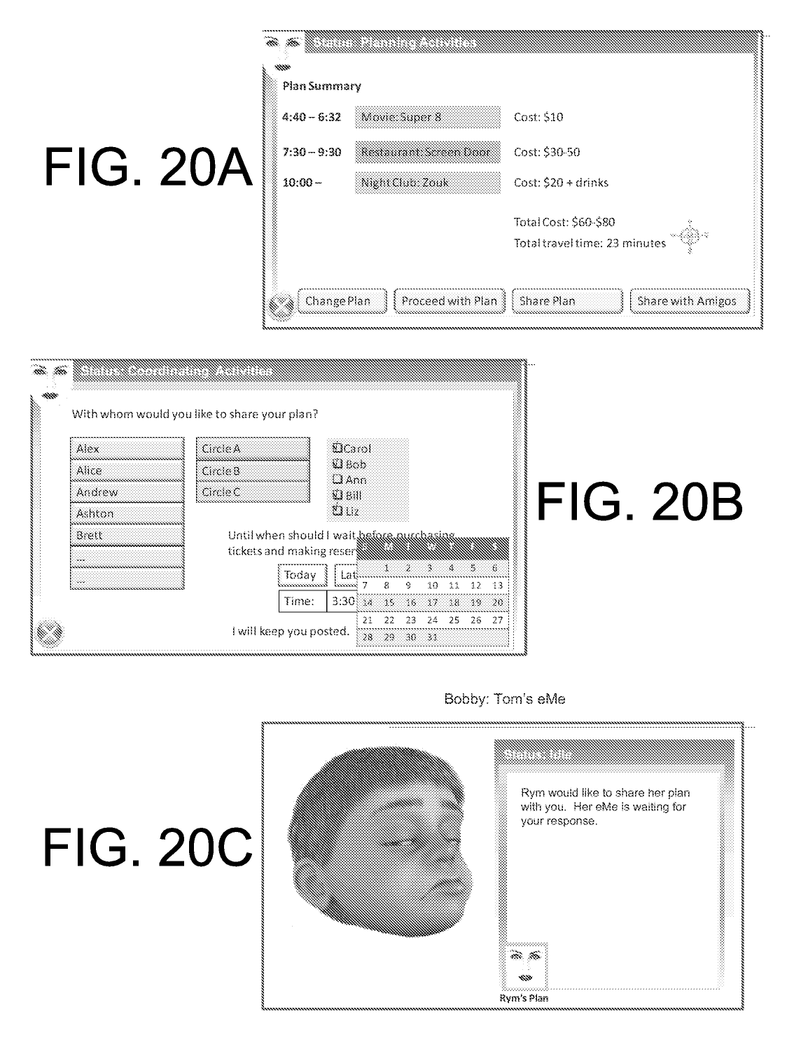

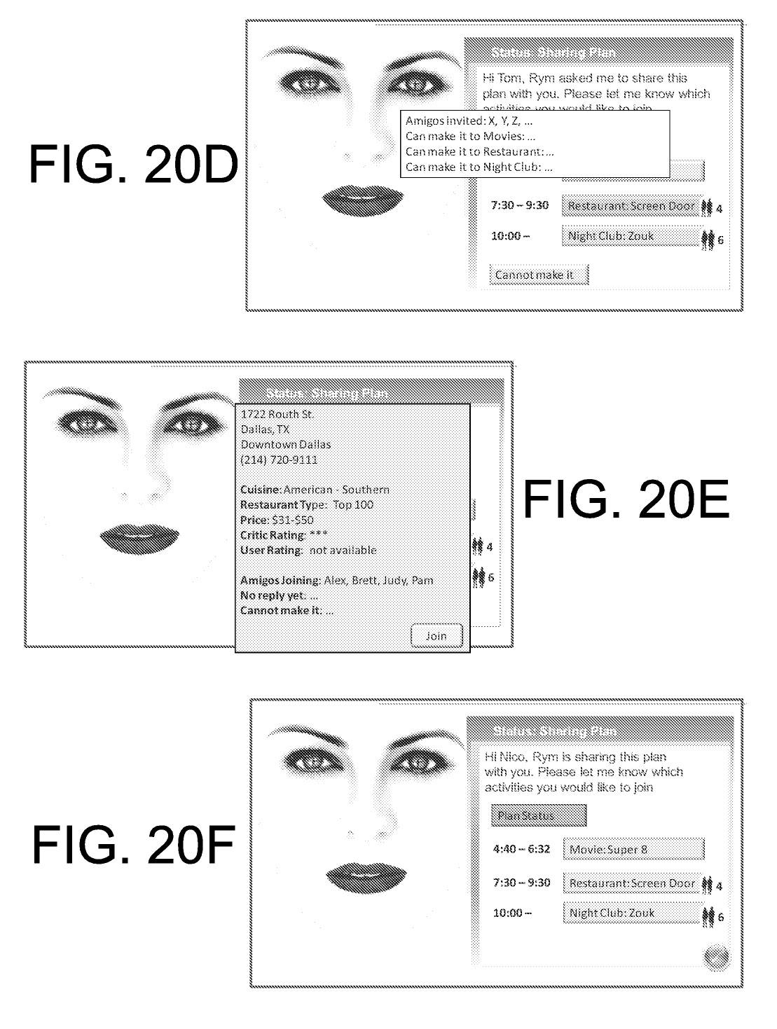

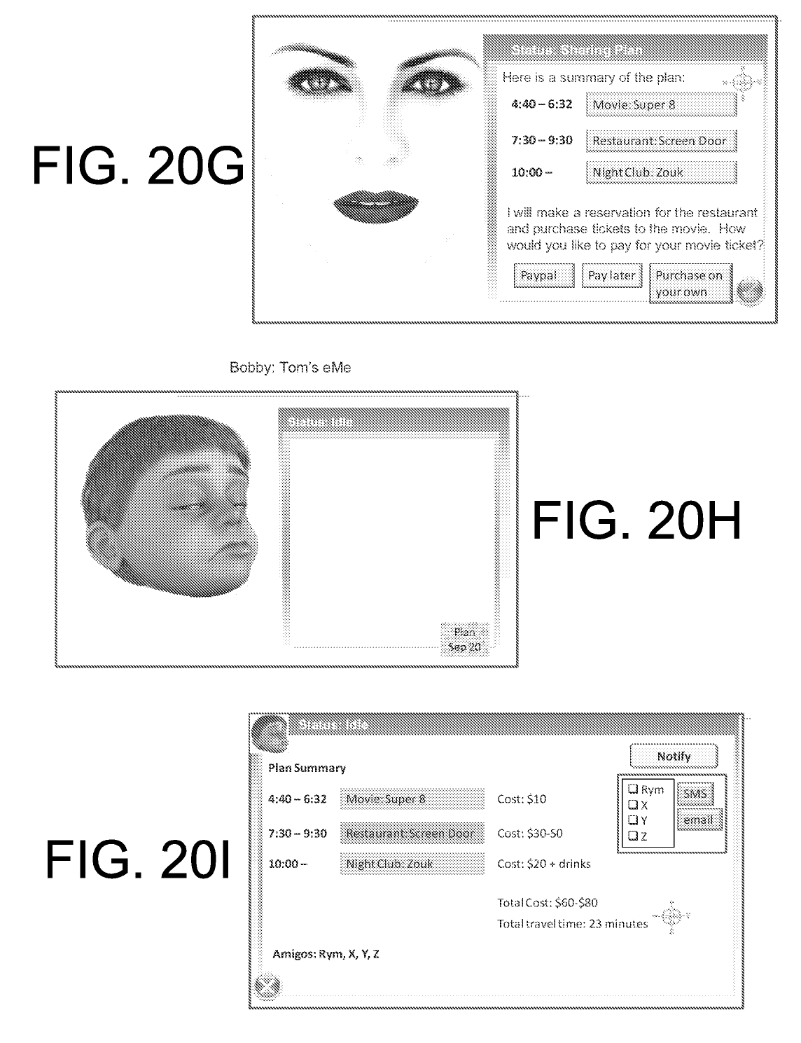

FIGS. 20A-20I provide screenshots of example graphical user interfaces for sharing planned activities with other users according to an illustrative embodiment.

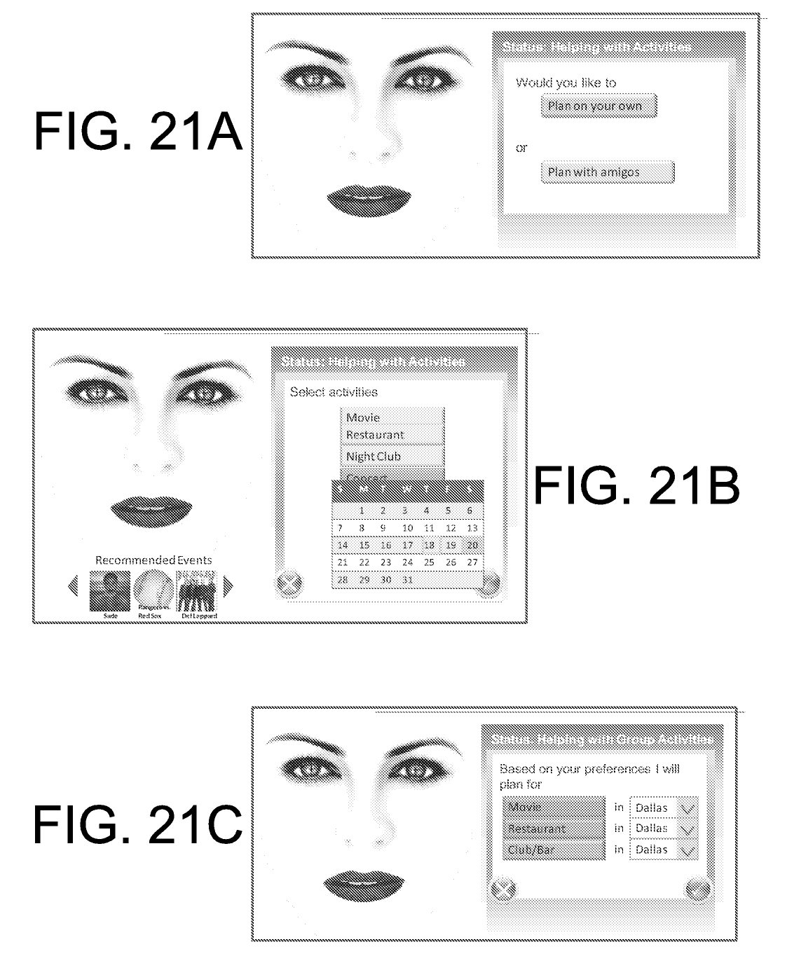

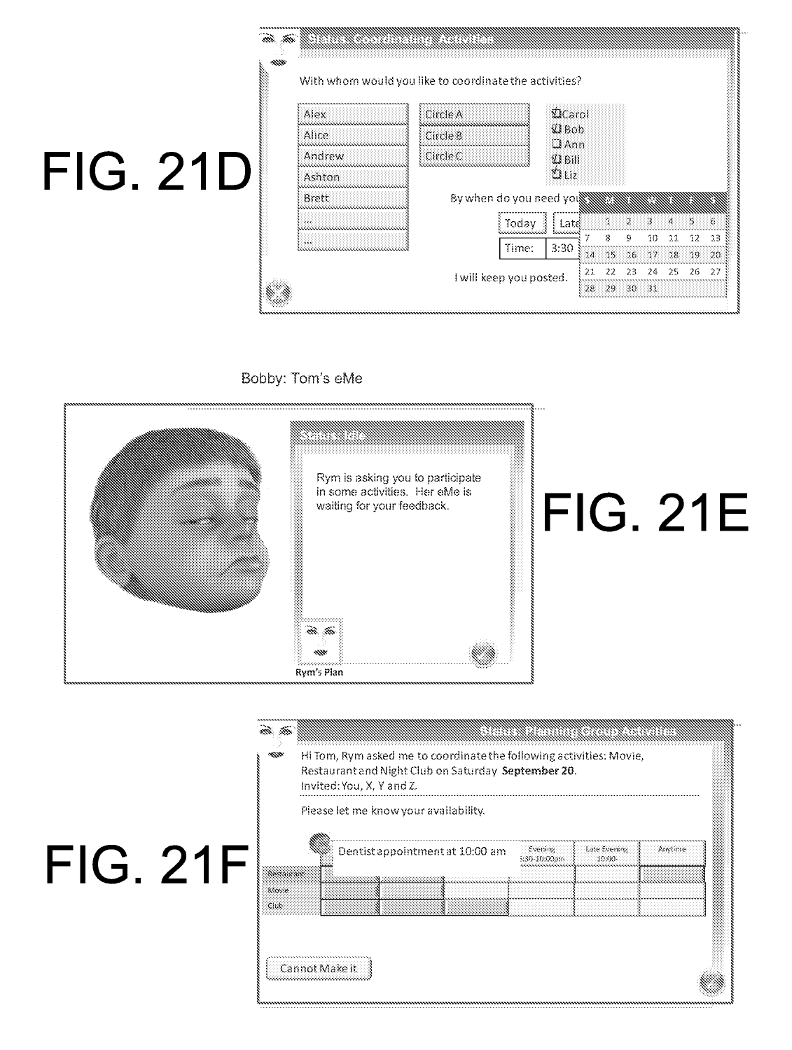

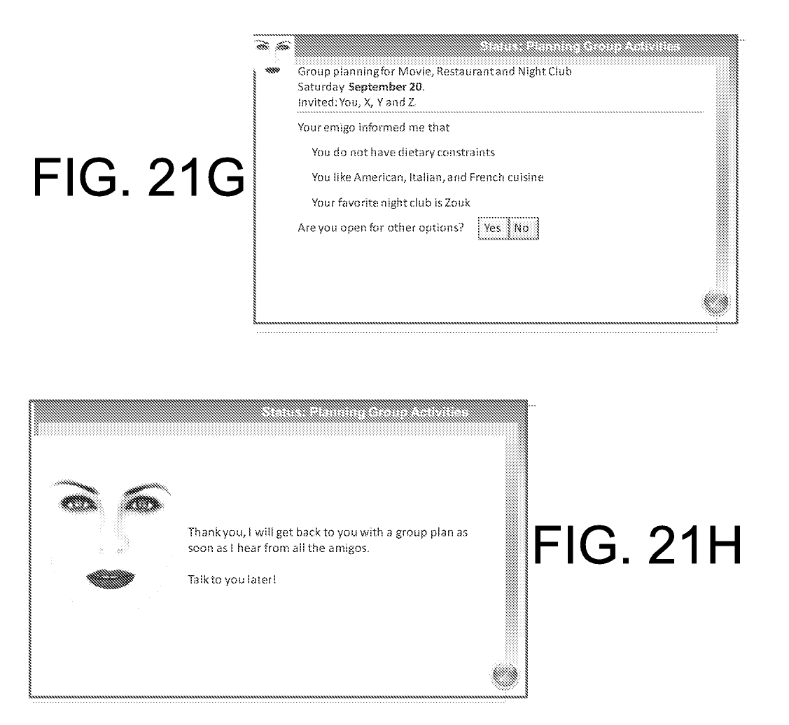

FIGS. 21A-21H provide screenshots of example graphical user interfaces for planning group activities according to an illustrative embodiment. In this example, a user may select to plan events alone, or may opt to coordinate the event planning events with other users. Options may also be provided that enable the group planning to be fully or semi automatic. For instance, if the user has a calendaring system, such as Google calendar, the user may rely on the interfacing system to automatically determine open blocks of time and determine appropriate activities for scheduling. In this manner, the user may not need to participate in the planning process, but rather the data collection and the analysis performed by the interfacing system to schedule activities may be fully automated. In contrast, if the user does not have a calendaring system, the interfacing system may present options for selection by the user to schedule the events, as shown in FIGS. 21E-H.

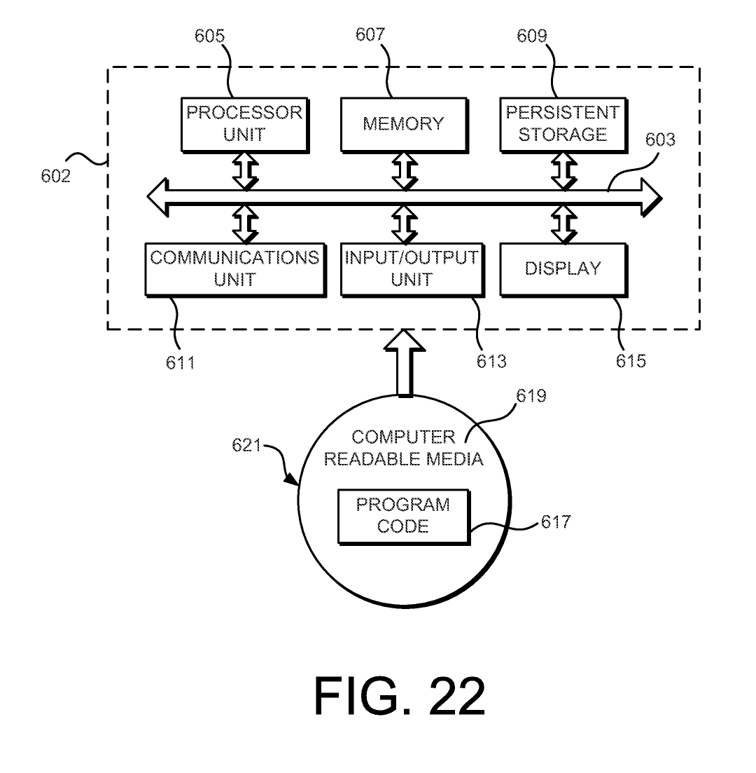

Referring to FIG. 22, a block diagram of a computing device 602 is shown in which the illustrative embodiments may be implemented. The computing device 602 may be amy of the communication devices 102, 118, 120, 126, 202, 254, 256, 258, 260 described in FIGS. 1-3. In another embodiment, the interfacing agents 106, 124, 206, 244, 246, 248, 250 described in FIGS. 1-3 may be implemented on the computing device 602. Computer-usable program code or instructions implementing the processes used in the illustrative embodiments may be located on the computing device 602. The computing device 602 includes a communications fabric 603, which provides communications between a processor unit 605, a memory 607, a persistent storage 609, a communications unit 611, an input/output (I/O) unit 613, and a display 615.

The processor unit 605 serves to execute instructions for software that may be loaded into the memory 607. The processor unit 605 may be a set of one or more processors or may be a multi-processor core, depending on the particular implementation. Further, the processor unit 605 may be implemented using one or more heterogeneous processor systems in which a main processor is present with secondary processors on a single chip. As another illustrative example, the processor unit 605 may be a symmetric multi-processor system containing multiple processors of the same type.

The memory 607, in these examples, may be, for example, a random access memory or any other suitable volatile or non-volatile storage device. The persistent storage 609 may take various forms depending on the particular implementation. For example, the persistent storage 609 may contain one or more components or devices. For example, the persistent storage 609 may be a hard drive, a flash memory, a rewritable optical disk, a rewritable magnetic tape, or some combination of the above. The media used by the persistent storage 609 also may be removable. For example, a removable hard drive may be used for the persistent storage 609.

The communications unit 611, in these examples, provides for communications with other data processing systems or communication devices. In these examples, the communications unit 611 may be a network interface card. The communications unit 611 may provide communications through the use of either or both physical and wireless communication links.

The input/output unit 613 allows for the input and output of data with other devices that may be connected to the computing device 602. For example, the input/output unit 613 may provide a connection for user input through a keyboard and mouse. Further, the input/output unit 613 may send output to a processing device. In the case in which the computing device 602 is a cellular phone, the input/output unit 613 may also allow devices to be connected to the cellular phone, such as microphones, headsets, and controllers. The display 615 provides a mechanism to display information to a user, such as a graphical user interface.

Instructions for the operating system and applications or programs are located on the persistent storage 609. These instructions may be loaded into the memory 607 for execution by the processor unit 605. The processes of the different embodiments may be performed by the processor unit 605 using computer-implemented instructions, which may be located, in a memory, such as the memory 607. These instructions are referred to as program code, computer-usable program code, or computer-readable program code that may be read and executed by a processor in the processor unit 605. The program code in the different embodiments may be embodied on different physical or tangible computer-readable media, such as the memory 607 or the persistent storage 609.

Program code 617 is located in a functional form on a computer-readable media, or computer-readable storage media, 619 and may be loaded onto or transferred to the computing device 602 for execution by the processor unit 605. The program code 617 and the computer-readable media 619 form computer program product 621 in these examples. In one embodiment, the computer program product 621 is the interfacing agent 106 or 206 described in FIG. 1 or 2, respectively. In this embodiment, the program code 617 may include computer-usable program code capable of receiving a set of user attributes associated with a user to form a user profile, receiving a request for data from the user, and sending the request to one or more service providers. The program code 617 may also include computer-usable program code capable of receiving response data from the one or more service providers in response to sending the request to the one or more service providers. The program code 617 may also include computer-usable program code capable of filtering the response data from the one or more service providers using the user profile to form user-customized response data, and presenting the user-customized response data to the user.

In another embodiment, the program code 617 may include computer-usable program code capable of receiving a set of user attributes associated with a user to form a user profile, receiving a request for data from the user, and sending the request to one or more interfacing agents. Each of the one or more interfacing agents is associated with a respective user profile for a respective user. The program code 617 may also include computer-usable program code capable of receiving response data from the one or more interfacing agents in response to sending the request to the one or more interfacing agents. The program code 617 may also include computer-usable program code capable of filtering the response data from the one or more interfacing agents using the user profile to form user-customized response data, and presenting the user-customized response data to the user. Any combination of the above-mentioned computer-usable program code may be implemented in the dode 617, and any functions of the illustrative embodiments may be implemented in the program code 617.

In one example, the computer-readable media 619 may be in a tangible form, such as, for example, an optical or magnetic disc that is inserted or placed into a drive or other device that is part of the persistent storage 609 for transfer onto a storage device, such as a hard drive that is part of the persistent storage 609. In a tangible form, the computer-readable media 619 also may take the form of a persistent storage, such as a hard drive or a flash memory that is connected to the computing device 602. The tangible form of the computer-readable media 619 is also referred to as computer recordable storage media.

Alternatively, the program code 617 may be transferred to the computing device 602 from the computer-readable media 619 through a communication link to the communications unit 611 or through a connection to the input/output unit 613. The communication link or the connection may be physical or wireless in the illustrative examples. The computer-readable media 619 also may take the form of non-tangible media, such as communication links or wireless transmissions containing the program code 617. In one embodiment, the program code 617 is delivered to the computing device 602 over the Internet.

The different components illustrated for the computing device 602 are not meant to provide architectural limitations to the manner in which different embodiments may be implemented. The different illustrative embodiments may be implemented in a data processing system including components in addition to or in place of those illustrated for computing device 602. Other components shown in FIG. 22 can be varied from the illustrative examples shown.

As one example, a storage device in the computing device 602 is any hardware apparatus that may store data. The memory 607, the persistent storage 609, and the computer-readable media 619 are examples of storage devices in a tangible form.

In another example, a bus system may be used to implement the communications fabric 603 and may be comprised of one or more buses, such as a system bus or an input/output bus. Of course, the bus system may be implemented using any suitable type of architecture that provides for a transfer of data between different components or devices attached to the bus system. Additionally, the communications unit 611 may include one or more devices used to transmit and receive data, such as a modem or a network adapter. Further, a memory may be, for example, the memory 607 or a cache such as found in an interface and memory controller hub that may be present in the communications fabric 603.

As used herein, the terms first, second, third, etc. used in relation to an element (e.g., first service provider, second service provider, etc.) are for reference or identification purposes only, and these terms, unless otherwise indicated, are not intended to describe or suggest, a number, order, source, purpose, or substantive quality for any element for which such a term is used.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A method for interfacing a user to service providers, the method comprising:
receiving a set of user attributes associated with a user to form a user profile;
receiving a request for data from the user;
sending the request to one or more service providers;
receiving response data from the one or more service providers in response to sending the request to the one or more service providers;
filtering the response data from the one or more service providers using the user profile to form user-customized response data; and
presenting the user-customized response data to the user.

2. The method of claim 1, wherein receiving the request for data from the user comprises receiving one or more search terms from the user;
wherein sending the request to the one or more service providers comprises sending the one or more search terms to one or more search engine service providers;
wherein receiving the response data from the one or more service providers comprises receiving one or more search results from the one or more search engine service providers;
wherein filtering the response data from the one or more service providers using the user profile to form the user-customized response data comprises filtering the one or more search results using the user profile to form user-customized search results; and
wherein presenting the user-customized response data to the user comprises presenting the user-customized search results to the user.

3. The method of claim 1, further comprising:
changing the request for data from the user using the user profile to form a modified request;
wherein sending the request to the one or more service providers comprises sending the modified request to the one or more service providers.

4. The method of claim 3, wherein receiving the request for data from the user comprises receiving one or more search terms from the user;
wherein changing the request for data from the user using the user profile to form the modified request comprises changing the one or more search terms from the user using the user profile to form a set of modified search terms;
wherein sending the modified request to the one or more service providers comprises sending the set of modified search terms to one or more search engine service providers;
wherein receiving the response data from the one or more service providers comprises receiving one or more search results from the one or more search engine service providers;
wherein filtering the response data from the one or more service providers using the user profile to form the user-customized response data comprises filtering the one or more search results using the user profile to form user-customized search results; and
wherein presenting the user-customized response data to the user comprises presenting the user-customized search results to the user.

5. The method of claim 4, wherein changing the one or more search terms from the user using the user profile to form the set of modified search terms comprises adding additional search terms to the one or more search terms using the user profile to form the set of modified search terms.

6. The method of claim 1, wherein changing the request for data from the user using the user profile to form the modified request comprises changing the request for data from the user using a first set of user attributes of the user profile to form the modified request; and
wherein filtering the response data from the one or more service providers using the user profile to form the user-customized response data comprises filtering the response data from the one or more service providers using a second set of user attributes of the user profile to form the user-customized response data.

7. The method of claim 6, wherein each of the user attributes in the first set of user attributes is different from each of the user attributes in the second set of user attributes.

8. The method of claim 1, wherein the request for data is associated with a particular type of service; and
wherein sending the request to the one or more service providers comprises sending the request to a plurality of service providers, each of the plurality of service providers associated with the particular type of service.

9. The method of claim 1, wherein sending the request to the one or more service providers comprises sending the request to at least one of a social networking service provider, a news service provider, a search engine service provider, or another interfacing agent.

10. The method of claim 1, wherein filtering the response data from the one or more service providers using the user profile to form the user-customized response data comprises comparing the response data to the user profile to determine the user-customized response data.

11. The method of claim 10, wherein comparing the response data to the user profile to determine the user-customized response data comprises:
retaining one or more portions of the response data relevant to the user profile for inclusion into the user-customized response data; and
discarding one or more portions of the response data non-relevant to the user profile for exclusion from the user-customized response data.

12. The method of claim 1, wherein the method is implemented by an interfacing agent executed by a communication device associated with the user.

13. The method of claim 12, wherein an agent host comprises a set of interfacing agents and a set of service agents, wherein each interfacing agent in the set of interfacing agents is associated with a particular user, and wherein each service agent in the set of service agents performs a particular task for one or more of the interfacing agents.

14. The method of claim 13, further comprising:
responsive to a determination that an agent host in a set of agent hosts is over-utilized, migrating a subset of interfacing agents from the over-utilized agent host to a less utilized agent host; and
responsive to a determination that all agent hosts in the set of agent hosts are over-utilized, creating a new agent host and migrating a subset of interfacing agents from the over-utilized agent hosts to the new agent host.

15. The method of claim 1, wherein sending the request to one or more service providers and receiving response data from the one or more service providers in response to sending the request to the one or more service providers is performed via a scraper.

16. A method for providing an interface between interfacing agents, the method comprising:
receiving a set of user attributes associated with a user to form a user profile;
receiving a request for data from the user;
sending the request to one or more interfacing agents, each of the one or more interfacing agents associated with a respective user profile for a respective user;
receiving response data from the one or more interfacing agents in response to sending the request to the one or more interfacing agents;
filtering the response data from the one or more interfacing agents using the user profile to form user-customized response data; and
presenting the user-customized response data to the user.

17. The method of claim 16, wherein filtering the response data from the one or more interfacing agents using the user profile to form the user-customized response data comprises comparing the user profile of the user to the one or more respective user profiles for the one or more respective users associated with the one or more interfacing agents to determine the user-customized response data.

18. The method of claim 16, wherein receiving the request for data from the user comprises receiving a request for user-identifying data for one or more users;
wherein receiving the response data from the one or more interfacing agents comprises receiving user-identifying response data for at least a portion of the respective users associated with the one or more interfacing agents;
wherein filtering the response data from the one or more interfacing agents using the user profile to form the user-customized response data comprises filtering the user-identifying response data using the user profile to form user-customized user-identifying data; and
wherein presenting the user-customized response data to the user comprises presenting the user-customized user-identifying data to the user.

19. The method of claim 16, further comprising:
interfacing an interfacing agent associated with the user with one or more interfacing agents associated with respective users identified by the user-customized user-identifying data.

20. The method of claim 16, wherein the response data comprises data associated with the respective user profiles for the one or more interfacing agents.

21. A system for interfacing a user, the system comprising:
an interfacing agent implementable on a communication device, the interfacing agent adapted to communicate with a plurality of service providers and external interfacing agents, the interfacing agent to receive a request for data from a user and send the request to at least one of the plurality of service providers and external interfacing agents, the interfacing agent to receive response data from the at least one of the plurality of service providers and external interfacing agents in response to sending the request to the at least one of the plurality of service providers and external interfacing agents, the interfacing agent further comprising:
a user profile comprising a set of user attributes associated with the user; and
a filtering engine to filter the response data from the at least one of the plurality of service providers and external interfacing agents using the user profile to form user-customized response data, the interfacing agent to present the user-customized response data to the user.

22. The system of claim 21, wherein the interfacing agent further comprises:
a request customization engine to change the request for data from the user using the user profile to form a modified request, the interfacing agent to send the modified request to the at least one of the plurality of service providers and external interfacing agents.

23. The system of claim 21, wherein the interfacing agent is adapted to communicate with the plurality of service providers via a scraper.
